(19) United States
(12) Patent Application Publication
(10) Pub. No.: US 2003/0195983 A1
(43) Pub. Date: Oct. 16, 2003

(54) Network congestion management using aggressive timers

(76) Inventor: Michael R. Krause, Boulder Creek, CA (US)

Correspondence Address: HEWLETT-PACKARD COMPANY, Intellectual Property Administration, P.O. Box 272400, Fort Collins, CO, 80527-2400, US

(21) Appl. No.: 10/442,401

(22) Filed: May 21, 2003

Related U.S. Application Data
(63) Continuation-in-part of application No. 09/578,019, filed on May 24, 2000.
Application No. 09/578,019 is a continuation-in-part of application No. 09/578,155, filed on May 23, 2000.
(60) Provisional application No. 60/135,664, filed on May 24, 1999.
(60) Provisional application No. 60/154,150, filed on Sep. 15, 1999.

(51) Int. Cl. G06F 15/173

(52) U.S. Cl. 709/238

(57) ABSTRACT

A network system includes links and end stations coupled between the links. Types of end stations include endnodes which originate or consume frames and routing devices which route frames between the links. At least one end station includes an aggressive timer adapted to respond to an occurrence of at least one condition of delayed frame transmission progress, to provide a frame delay indication when the at least one condition exists for a duration that exceeds a variable timing threshold. The variable timing threshold is configurable based on at least one network system attribute.

### CROSS REFERENCE TO RELATED APPLICATIONS

This patent application is a Continuation-in-part of U.S. patent application Ser. No. 09/578,019, entitled “RELIABLE MULTICAST,” filed May 24, 2000, and having Attorney Docket No. HP PDNO 10991834-2, which is herein incorporated by reference. U.S. patent application Ser. No. 09/578,019 is a Continuation-in-Part Application of U.S. patent application Ser. No. 09/578,155, filed May 23, 2000, entitled “RELIABLE DATAGRAM” having Attorney Docket No. HP PDNO 10991833-1 which is herein incorporated by reference. U.S. patent application Ser. No. 09/578,019 also claimed the benefit of the filing date of U.S. Provisional Patent Applications Serial No. 60/135,664, filed May 24, 1999 and having Attorney Docket No. HP PDNO 10991654-1; and Ser. No. 60/154,150, filed Sep. 15, 1999 and having Attorney Docket No. HP PDNO 10992562-1, both of which are herein incorporated by reference.

### THE FIELD OF THE INVENTION

The present invention generally relates to communication in network systems and more particularly to network system congestion management.

### BACKGROUND OF THE INVENTION

A traditional network system, such as a computer system, has an implicit ability to communicate between its own local processors and from the local processors to its own I/O adapters and the devices attached to its I/O adapters. Traditionally, processors communicate with other processors, memory, and other devices via processor-memory buses. I/O adapters communicate via buses attached to processor-memory buses. The processors and I/O adapters on a first computer system are typically not directly accessible to other processors and I/O adapters located on a second computer system.

In conventional distributed computer systems, distributed processes, which are on different nodes in the distributed computer system, typically employ transport services to communicate. A source process on a first node communicates messages to a destination process on a second node via a transport service. A message is herein defined to be an application-defined unit of data exchange, which is a primitive unit of communication between cooperating sequential processes. Messages are typically packetized into frames for communication on an underlying communication services/fabrics. A frame is herein defined to be one unit of data encapsulated by a physical network protocol header and/or trailer.

Messages communicated over the underlying communication services/fabrics can often experience congestion for various reasons, such as head of line blocking. There are conventional congestion control mechanisms. Congestion control mechanisms typically fall into three categories which include congestion detection mechanisms; congestion reporting mechanisms; and congestion response mechanisms. Congestion reporting mechanisms report the occurrence of congestion provided from congestion detection mechanisms possibly for short term use in alleviating congestion and possibly for long term network management. The congestion response mechanisms attempt to alleviate or remove congestion. Congestion in large distributed computer systems is a significant problem today, especially in infrastructures of remote computer systems having congestion resulting from message traffic over an internet or intranet coupling the remote computer systems.

Certain conventional distributed computer systems employ various means for addressing network traffic congestion. One known method is to drop frames that fail to make forward progress over a defined period of time. One realization of the method involves the use of forward progress timers implemented to prevent deadlock, or abnormal congestion, of a transmission port. Forward progress timers are typically implemented to expire 100-500 milliseconds after their initiation. Thus, relative to network transmission rates, a forward progress timer is quite coarse, as its purpose is to relieve severe deadlock.

On expiration of the forward progress timer, one or more frames are typically purged from the port. For example, the current stalled frame can be dropped from the queue. Alternatively, all packets in a queue targeting the congested port can be dropped. Typically, the sender of a dropped frame will become aware of the transmission failure via a protocol layer, such as by nonreceipt of an acknowledgment frame (ACK), and will respond to the inferred congestion assumed to be the cause of the transmission failure. Example sender responses include re-sending of the frame, and reducing of the transmission rate.

In practice, a plurality of senders are often targeting a congestion-prone port. As a result, frame dropping at times of congestion can lead to a problem of synchronization, where sources simultaneously respond to perceived congestion by reducing their respective transmission rates. As a result, the previously-congested port becomes under-utilized for some time. Hence, a cycle of congestion and under-utilization can develop, resulting in reduced overall throughput and efficiency.

One solution to the problem of synchronization is the use of random frame dropping, whereby only randomly-selected frames are dropped upon the expiration of a forward progress timer. Senders of the randomly-dropped frames perceive the failure of transmission as congestion, and respond to the perceived congestion. Consequently, the random frame dropping can dampen the aggregate global response to a port's congestion, resulting in greater port utilization, throughput, and efficiency.

A further improvement involves weighted random algorithms, which treat frames of a higher priority more favorably while employing randomization to avoid synchronization. Random and weighted-random-based techniques have been implemented in early detection schemes, such as disclosed in Weighted Random Early Detection on the Cisco 12000 Series Router, available at http://www.cisco.com/univercd/cc/td/doc/product/software/ios112/ios112p/gsr/w red_gs.pdf. Early detection is premised on anticipating congestion and responding before it becomes severe. To address the problem of a forward progress timer's coarse granularity, some anticipatory methods use a queue size measuring technique for estimating a congestion level. One drawback of such queue size-based approaches to congestion management, is their inability to provide a time-based service guarantee for high priority frames that require a minimum-delay service priority, such as multimedia or real-time applications.

Network utilization and associated congestion continues to grow as a result of the increasing scale of distributed computer systems, variety of network elements, and increasingly-complex applications. For example, the expanding use of multimedia and real-time applications, and their associated bandwidth requirements, is fueling the need for specialized congestion management techniques and policies.

For reasons stated above and for other reasons presented in the Description of the Preferred Embodiments section of the present specification, there is a need for a congestion management technique that improves network utilization, throughput, and efficiency.

### SUMMARY OF THE INVENTION

One aspect of the present invention provides a network system having links and end stations coupled between the links. Types of end stations include endnodes which originate or consume frames and routing devices which route frames between the links. At least one end station includes an aggressive timer adapted to respond to an occurrence of at least one condition of delayed frame transmission progress, to provide a frame delay indication when the at least one condition exists for a duration that exceeds a variable timing threshold. The variable timing threshold is configurable based on at least one network system attribute.

### BRIEF DESCRIPTION OF THE DRAWINGS

FIG. 1 is a diagram of a distributed computer system.

FIG. 2 is a diagram of an example host processor node for the computer system of FIG. 1.

FIG. 3 is a diagram of a portion of a distributed computer system employing a reliable connection service to communicate between distributed processes.

FIG. 4 is a diagram of a portion of distributed computer system employing a reliable datagram service to communicate between distributed processes.

FIG. 5 is a diagram of an example host processor node for operation in a distributed computer system.

FIG. 6 is a diagram of a portion of a distributed computer system illustrating subnets in the distributed computer system.

FIG. 7 is a diagram of a switch for use in a distributed computer system.

FIG. 8 is a diagram of a portion of a distributed computer system.

FIG. 9A is a diagram of a work queue element (WQE) for operation in the distributed computer system of FIG. 8.

FIG. 9B is a diagram of the packetization process of a message created by the WQE of FIG. 9A into frames and flits.

FIG. 10A is a diagram of a message being transmitted with a reliable transport service illustrating frame transactions.

FIG. 10B is a diagram illustrating a reliable transport service illustrating flit transactions associated with the frame transactions of FIG. 10A.

FIG. 11 is a diagram of a layered architecture.

FIG. 12 is a diagram illustrating a method for recognizing and managing network system congestion using congestion detection, reporting, and responding mechanisms.

FIG. 13A is a simplified diagram illustrating one embodiment of a network system that includes an end station comprising an aggressive timer according to one embodiment of the present invention.

FIG. 13B is a diagram illustrating an exemplary end station of FIG. 13A that includes an aggressive timer adapted to monitor the end station's port according to one embodiment of the present invention.

FIG. 13C is a diagram of an exemplary end station of FIG. 13A that runs an application program according to one embodiment of the present invention.

FIG. 13D is a diagram of an exemplary end station of FIG. 13A that includes a traffic congestion manager according to the present invention.

FIG. 14 is a diagram of an example of one embodiment of a routing element having a network traffic congestion manager utilizing aggressive timers.

FIG. 15 is a flow diagram illustrating an aggressive timer's and traffic congestion manager's operation in the exemplary routing element of FIG. 14.

FIG. 16 is a diagram of one embodiment of an end station utilizing an aggressive timer and a forward progress timer.

### DESCRIPTIONS OF THE PREFERRED EMBODIMENTS

In the following detailed description of the preferred embodiments, reference is made to the accompanying drawings which form a part hereof, and in which is shown by way of illustration specific embodiments in which the invention may be practiced. It is to be understood that other embodiments may be utilized and structural or logical changes may be made without departing from the scope of the present invention. The following detailed description, therefore, is not to be taken in a limiting sense, and the scope of the present invention is defined by the appended claims.

One aspect of the present invention is directed to a method and apparatus providing an aggressive timer-based congestion manager. This aspect facilitates the application of various criteria for selective treatment of frames based on frame or network system attributes as part of congestion detection, reporting, and/or response mechanisms. In one embodiment, the congestion manager supports the enforcement of policies set by network fabric management. In one embodiment, the congestion manager is employed on a network entity, including a network fabric element or end station, such as a switch, router, or endnode.

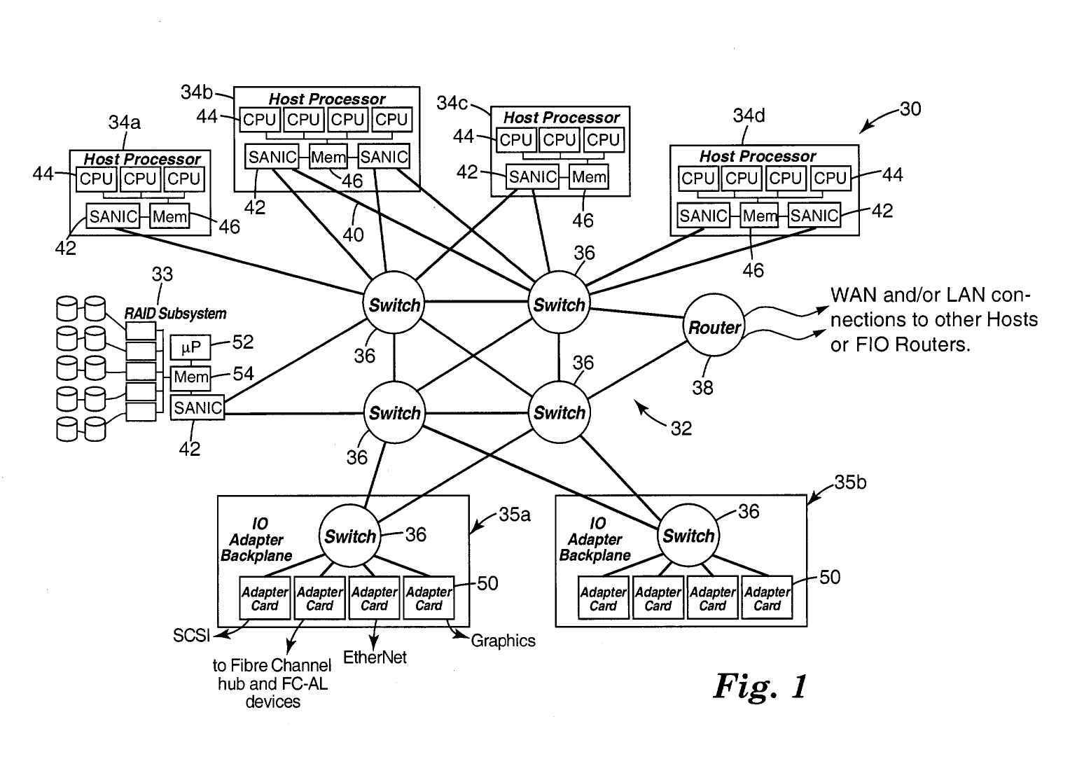

An example embodiment of a distributed computer system is illustrated generally at 30 in FIG. 1. Distributed computer system 30 is provided merely for illustrative purposes, and the embodiments of the present invention described below can be implemented on network systems of numerous other types and configurations. For example, network systems implementing the present invention can range from a small server with one processor and a few input/output (I/O) adapters to massively parallel supercomputer systems with hundreds or thousands of processors and thousands of I/O adapters.

Furthermore, the present invention can be implemented in an infrastructure of remote computer systems connected by an internet or intranet.

Distributed computer system 30 includes a system area network (SAN) 32 which is a high-bandwidth, low-latency network interconnecting nodes within distributed computer system 30. A node is herein defined to be any device attached to one or more links of a network and forming the origin and/or destination of messages within the network. In the example distributed computer system 30, nodes include host processors 34a-34d; redundant array independent disk (RAID) subsystem 33; and I/O adapters 35a and 35b. The nodes illustrated in FIG. 1 are for illustrative purposes only, as SAN 32 can connect any number and any type of independent processor nodes, I/O adapter nodes, and I/O device nodes. Any one of the nodes can function as an endnode, which is herein defined to be a device that originates or finally consumes messages or frames in the distributed computer system.

A message is herein defined to be an application-defined unit of data exchange, which is a primitive unit of communication between cooperating sequential processes. A frame is herein defined to be one unit of data encapsulated by a physical network protocol header and/or trailer. The header generally provides control and routing information for directing the frame through SAN 32. The trailer generally contains control and cyclic redundancy check (CRC) data for ensuring frames are not delivered with corrupted contents.

SAN 32 is the communications and management infrastructure supporting both I/O and interprocess communication (IPC) within distributed computer system 30. SAN 32 includes a switched communications fabric (SAN FABRIC) allowing many devices to concurrently transfer data with high-bandwidth and low latency in a secure, remotely managed environment. Endnodes can communicate over multiple ports and utilize multiple paths 30 through the SAN fabric. The multiple ports and paths through SAN 32 can be employed for fault tolerance and increased bandwidth data transfers.

SAN 32 includes switches 36 and routers 38. A switch is herein defined to be a device that connects multiple links 40 together and allows routing of frames from one link 40 to another link 40 within a subnet using a small header destination ID field. A router is herein defined to be a device that connects multiple links 40 together and is capable of routing frames from one link 40 in a first subnet to another link 40 in a second subnet using a large header destination address or source address.

In one embodiment, a link 40 is a full duplex channel between any two network fabric elements, such as endnodes, switches 36, or routers 38. Example suitable links 40 include, but are not limited to, copper cables, optical cables, and printed circuit copper traces on backplanes and printed circuit boards.

Endnodes, such as host processor endnodes 34 and I/O adapter endnodes 35, generate request frames and return acknowledgment frames. By contrast, switches 36 and routers 38 do not generate and consume frames. Switches 36 and routers 38 simply pass frames along. In the case of switches 36, the frames are passed along unmodified. For routers 38, the network header is modified slightly when the frame is routed. Endnodes, switches 36, and routers 38 are collectively referred to as end stations.

In distributed computer system 30, host processor nodes 34a-34d and RAID subsystem node 33 include at least one system area network interface controller (SANIC) 42. In one embodiment, each SANIC 42 is an endpoint that implements the SAN 32 interface in sufficient detail to source or sink frames transmitted on the SAN fabric. The SANICs 42 provide an interface to the host processors and I/O devices. In one embodiment the SANIC is implemented in hardware. In this SANIC hardware implementation, the SANIC hardware offloads much of CPU and I/O adapter communication overhead. This hardware implementation of the SANIC also permits multiple concurrent communications over a switched network without the traditional overhead associated with communicating protocols. In one embodiment, SAN 32 provides the I/O and IPC clients of distributed computer system 30 zero processor-copy data transfers without involving the operating system kernel process, and employs hardware to provide reliable, fault tolerant communications.

As indicated in FIG. 1, router 38 is coupled to wide area network (WAN) and/or local area network (LAN) connections to other hosts or other routers 38.

The host processors 34a-34d include central processing units (CPUs) 44 and memory 46.

I/O adapters 35a and 35b include an I/O adapter backplane 48 and multiple I/O adapter cards 50. Example adapter cards 50 illustrated in FIG. 1 include an SCSI adapter card; an adapter card to fiber channel hub and FC-AL devices; an Ethernet adapter card; and a graphics adapter card. Any known type of adapter card can be implemented. I/O adapters 35a and 35b also include a switch 36 in the I/O adapter backplane 48 to couple the adapter cards 50 to the SAN 32 fabric.

RAID subsystem 33 includes a microprocessor 52, memory 54, read/write circuitry 56, and multiple redundant storage disks 58.

SAN 32 handles data communications for I/O and IPC in distributed computer system 30. SAN 32 supports high-bandwidth and scalability required for I/O and also supports the extremely low latency and low CPU overhead required for IPC. User clients can bypass the operating system kernel process and directly access network communication hardware, such as SANICs 42 which enable efficient message passing protocols. SAN 32 is suited to current computing models and is a building block for new forms of I/O and computer cluster communication. SAN 32 allows I/O adapter nodes to communicate among themselves or communicate with any or all of the processor nodes in distributed computer system 30. With an I/O adapter attached to SAN 32, the resulting I/O adapter node has substantially the same communication capability as any processor node in distributed computer system 30.

Channel and Memory Semantics

In one embodiment, SAN 32 supports channel semantics and memory semantics. Channel semantics is sometimes referred to as send/receive or push communication operations, and is the type of communications employed in a traditional I/O channel where a source device pushes data and a destination device determines the final destination of the data. In channel semantics, the frame transmitted from a source process specifies a destination processes' communication port, but does not specify where in the destination processes' memory space the frame will be written. Thus, in channel semantics, the destination process pre-allocates where to place the transmitted data.

In memory semantics, a source process directly reads or writes the virtual address space of a remote node destination process. The remote destination process need only communicate the location of a buffer for data, and does not need to be involved with the transfer of any data. Thus, in memory semantics, a source process sends a data frame containing the destination buffer memory address of the destination process. In memory semantics, the destination process previously grants permission for the source process to access its memory.

Channel semantics and memory semantics are typically both necessary for I/O and IPC. A typical I/O operation employs a combination of channel and memory semantics. In an illustrative example I/O operation of distributed computer system 30, host processor 34a initiates an I/O operation by using channel semantics to send a disk write command to I/O adapter 35b. I/O adapter 35b examines the command and uses memory semantics to read the data buffer directly from the memory space of host processor 34a. After the data buffer is read, I/O adapter 35b employs channel semantics to push an I/O completion message back to host processor 34a.

In one embodiment, distributed computer system 30 performs operations that employ virtual addresses and virtual memory protection mechanisms to ensure correct and proper access to all memory. In one embodiment, applications running in distributed computed system 30 are not required to use physical addressing for any operations.

Queue Pairs

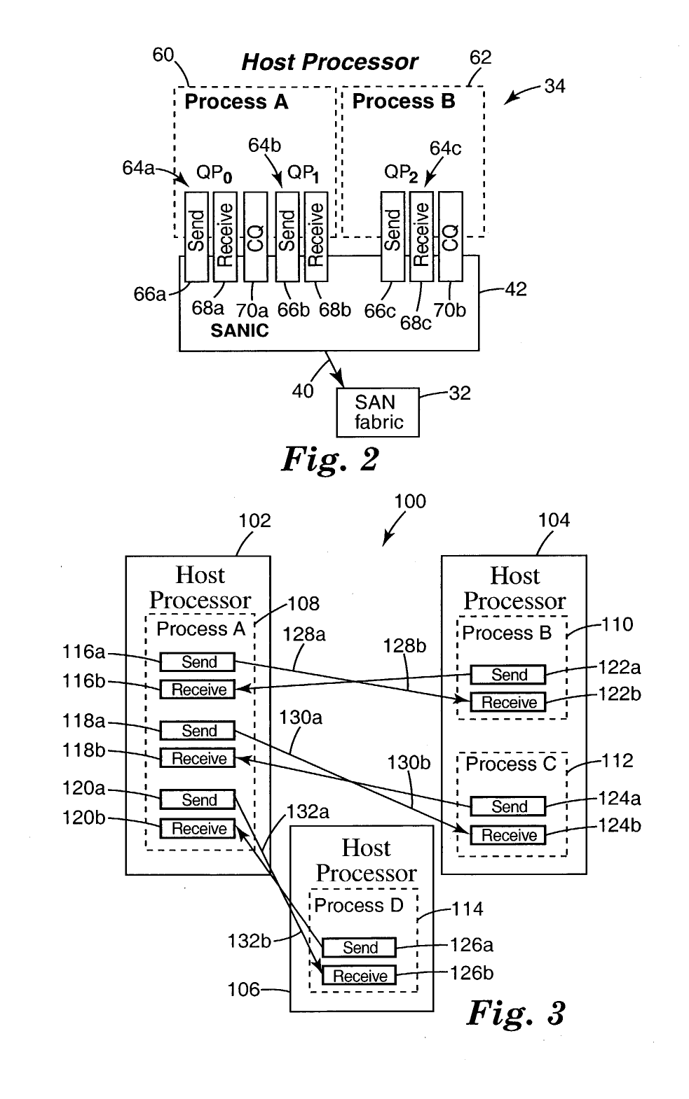

An example host processor node 34 is generally illustrated in FIG. 2. Host processor node 34 includes a process A indicated at 60 and a process B indicated at 62. Host processor node 34 includes SANIC 42. Host processor node 34 also includes queue pairs (QPs) 64a and 64b which provide communication between process 60 and SANIC 42. Host processor node 34 also includes QP 64c which provides communication between process 62 and SANIC 42. A single SANIC, such as SANIC 42 in a host processor 34, can support thousands of QPs. By contrast, a SAN interface in an I/O adapter 35 typically supports less than ten QPs.

Each QP 64 includes a send work queue 66 and a receive work queue 68. A process, such as processes 60 and 62, calls an operating-system specific programming interface which is herein referred to as verbs, which place work items, referred to as work queue elements (WQEs) onto a QP 64. A WQE is executed by hardware in SANIC 42. SANIC 42 is coupled to SAN 32 via physical link 40. Send work queue 66 contains WQEs that describe data to be transmitted on the SAN 32 fabric. Receive work queue 68 contains WQEs that describe where to place incoming data from the SAN 32 fabric.

Host processor node 34 also includes completion queue 70a interfacing with process 60 and completion queue 70b interfacing with process 62. The completion queues 70 contain information about completed WQEs. The completion queues are employed to create a single point of completion notification for multiple QPs. A completion queue entry is a data structure on a completion queue 70 that describes a completed WQE. The completion queue entry contains sufficient information to determine the QP that holds the completed WQE. A completion queue context is a block of information that contains pointers to, length, and other information needed to manage the individual completion queues.

Example WQEs include work items that initiate data communications employing channel semantics or memory semantics; work items that are instructions to hardware in SANIC 42 to set or alter remote memory access protections; and work items to delay the execution of subsequent WQEs posted in the same send work queue 66.

More specifically, example WQEs supported for send work queues 66 are as follows. A send buffer WQE is a channel semantic operation to push a local buffer to a remote QP's receive buffer. The send buffer WQE includes a gather list to combine several virtual contiguous local buffers into a single message that is pushed to a remote QP's receive buffer. The local buffer virtual addresses are in the address space of the process that created the local QP.

A remote direct memory access (RDMA) read WQE provides a memory semantic operation to read a virtually contiguous buffer on a remote node. The RDMA read WQE reads a virtually contiguous buffer on a remote endnode and writes the data to a virtually contiguous local memory buffer. Similar to the send buffer WQE, the local buffer for the RDMA read WQE is in the address space of the process that created the local QP. The remote buffer is in the virtual address space of the process owning the remote QP targeted by the RDMA read WQE.

A RDMA write WQE provides a memory semantic operation to write a virtually contiguous buffer on a remote node. The RDMA write WQE contains a scatter list of locally virtually contiguous buffers and the virtual address of the remote buffer into which the local buffers are written.

A RDMA FetchOp WQE provides a memory semantic operation to perform an atomic operation on a remote word. The RDMA FetchOp WQE is a combined RDMA read, modify, and RDMA write operation. The RDMA FetchOp WQE can support several read-modify-write operations, such as Compare and Swap if equal.

A bind/unbind remote access key (RKey) WQE provides a command to SANIC hardware to modify the association of a RKey with a local virtually contiguous buffer. The RKey is part of each RDMA access and is used to validate that the remote process has permitted access to the buffer.

A delay WQE provides a command to SANIC hardware to delay processing of the QP's WQEs for a specific time interval. The delay WQE permits a process to meter the flow of operations into the SAN fabric.

In one embodiment, receive work queues 68 only support one type of WQE, which is referred to as a receive buffer WQE. The receive buffer WQE provides a channel semantic operation describing a local buffer into which incoming send messages are written. The receive buffer WQE includes a scatter list describing several virtually contiguous local buffers. An incoming send message is written to these buffers. The buffer virtual addresses are in the address space of the process that created the local QP.

For IPC, a user-mode software process transfers data through QPs 64 directly from where the buffer resides in memory. In one embodiment, the transfer through the QPs bypasses the operating system and consumes few host instruction cycles. QPs 64 permit zero processor-copy data transfer with no operating system kernel involvement. The zero processor-copy data transfer provides for efficient support of high-bandwidth and low-latency communication.

Transport Services

When a QP 64 is created, the QP is set to provide a selected type of transport service. In one embodiment, a distributed computer system implementing the present invention supports four types of transport services.

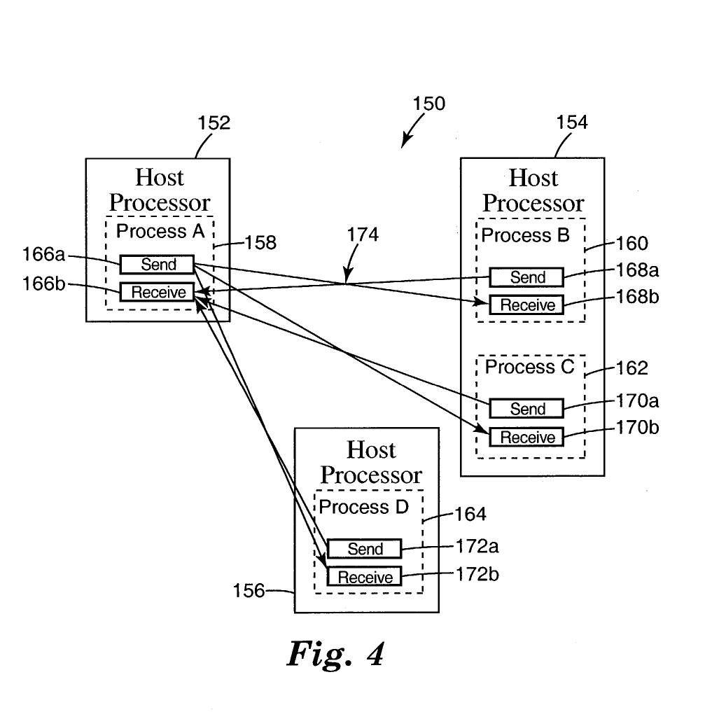

A portion of a distributed computer system employing a reliable connection service to communicate between distributed processes is illustrated generally at 100 in FIG. 3. Distributed computer system 100 includes a host processor node 102, a host processor node 104, and a host processor node 106. Host processor node 102 includes a process A indicated at 108. Host processor node 104 includes a process B indicated at 110 and a process C indicated at 112. Host processor node 106 includes a process D indicated at 114.

Host processor node 102 includes a QP 116 having a send work queue 116a and a receive work queue 116b; a QP 118 having a send work queue 118a and receive work queue 118b; and a QP 120 having a send work queue 120a and a receive work queue 120b which facilitate communication to and from process A indicated at 108. Host processor node 104 includes a QP 122 having a send work queue 122a and receive work queue 122b for facilitating communication to and from process B indicated at 110. Host processor node 104 includes a QP 124 having a send work queue 124a and receive work queue 124b for facilitating communication to and from process C indicated at 112. Host processor node 106 includes a QP 126 having a send work queue 126a and receive work queue 126b for facilitating communication to and from process D indicated at 114.

The reliable connection service of distributed computer system 100 associates a local QP with one and only one remote QP. Thus, QP 116 is connected to QP 122 via a non-sharable resource connection 128 having a non-sharable resource connection 128a from send work queue 116a to receive work queue 122b and a non-sharable resource connection 128b from send work queue 122a to receive work queue 116b. QP 118 is connected to QP 124 via a non-sharable resource connection 130 having a non-sharable resource connection 130a from send work queue 118a to receive work queue 124b and a non-sharable resource connection 130b from send work queue 124a to receive work queue 118b. QP 120 is connected to QP 126 via a non-sharable resource connection 132 having a non-sharable resource connection 132a from send work queue 120a to receive work queue 126b and a non-sharable resource connection 132b from send work queue 126a to receive work queue 120b.

A send buffer WQE placed on one QP in a reliable connection service causes data to be written into the receive buffer of the connected QP. RDMA operations operate on the address space of the connected QP.

The reliable connection service requires a process to create a QP for each process which is to communicate with over the SAN fabric. Thus, if each of N host processor nodes contain M processes, and all M processes on each node wish to communicate with all the processes on all the other nodes, each host processor node requires M²×(N−1) QPs. Moreover, a process can connect a QP to another QP on the same SANIC.

In one embodiment, the reliable connection service is made reliable because hardware maintains sequence numbers and acknowledges all frame transfers. A combination of hardware and SAN driver software retries any failed communications. The process client of the QP obtains reliable communications even in the presence of bit errors, receive buffer underruns, and network congestion. If alternative paths exist in the SAN fabric, reliable communications can be maintained even in the presence of failures of fabric switches or links.

In one embodiment, acknowledgements are employed to deliver data reliably across the SAN fabric. In one embodiment, the acknowledgement is not a process level acknowledgment, because the acknowledgment does not validate the receiving process has consumed the data. Rather, the acknowledgment only indicates that the data has reached its destination.

A portion of a distributed computer system employing a reliable datagram service to communicate between distributed processes is illustrated generally at 150 in FIG. 4. Distributed computer system 150 includes a host processor node 152, a host processor node 154, and a host processor node 156. Host processor node 152 includes a process A indicated at 158. Host processor node, 154 includes a process B indicated at 160 and a process C indicated at 162. Host processor node 156 includes a process D indicated at 164.

Host processor node 152 includes QP 166 having send work queue 166a and receive work queue 166b for facilitating communication to and from process A indicated at 158. Host processor node 154 includes QP 168 having send work queue 168a and receive work queue 168b for facilitating communication from and to process B indicated at 160. Host processor node 154 includes QP 170 having send work queue 170a and receive work queue 170b for facilitating communication from and to process C indicated at 162. Host processor node 156 includes QP 172 having send work queue 172a and receive work queue 172b for facilitating communication from and to process D indicated at 164. In the reliable datagram service implemented in distributed computer system 150, the QPs are coupled in what is referred to as a connectionless transport service.

For example, a reliable datagram service 174 couples QP 166 to QPs 168, 170, and 172. Specifically, reliable datagram service 174 couples send work queue 166a to receive work queues 168b, 170b, and 172b. Reliable datagram service 174 also couples send work queues 168a, 170a, and 172a to receive work queue 166b.

The reliable datagram service permits a client process of one QP to communicate with any other QP on any other remote node. At a receive work queue, the reliable datagram service permits incoming messages from any send work queue on any other remote node.

In one embodiment, the reliable datagram service employs sequence numbers and acknowledgments associated with each message frame to ensure the same degree of reliability as the reliable connection service. End-to-end (EE) contexts maintain end-to-end specific state to keep track of sequence numbers, acknowledgments, and time-out values. The end-to-end state held in the EE contexts is shared by all the connectionless QPs communicating between a pair of endnodes. Each endnode requires at least one EE context for every endnode it wishes to communicate with in the reliable datagram service (e.g., a given endnode requires at least N EE contexts to be able to have reliable datagram service with N other endnodes).

The reliable datagram service greatly improves scalability because the reliable datagram service is connectionless. Therefore, an endnode with a fixed number of QPs can communicate with far more processes and endnodes with a reliable datagram service than with a reliable connection transport service. For example, if each of N host processor nodes contain M processes, and all M processes on each node wish to communicate with all the processes on all the other nodes, the reliable connection service requires M²×(N−1) QPs on each node. By comparison, the connectionless reliable datagram service only requires M QPs+(N−1) EE contexts on each node for exactly the same communications.

A third type of transport service for providing communications is a unreliable datagram service. Similar to the reliable datagram service, the unreliable datagram service is connectionless. The unreliable datagram service is employed by management applications to discover and integrate new switches, routers, and endnodes into a given distributed computer system. The unreliable datagram service does not provide the reliability guarantees of the reliable connection service and the reliable datagram service. The unreliable datagram service accordingly operates with less state information maintained at each endnode.

A fourth type of transport service is referred to as raw datagram service and is technically not a transport service. The raw datagram service permits a QP to send and to receive raw datagram frames. The raw datagram mode of operation of a QP is entirely controlled by software. The raw datagram mode of the QP is primarily intended to allow easy interfacing with traditional internet protocol, version 6 (IPv6) LAN-WAN networks, and further allows the SANIC to be used with full software protocol stacks to access transmission control protocol (TCP), user datagram protocol (UDP), and other standard communication protocols. Essentially, in the raw datagram service, SANIC hardware generates and consumes standard protocols layered on top of IPv6, such as TCP and UDP. The frame header can be mapped directly to and from an IPv6 header. Native IPv6 frames can be bridged into the SAN fabric and delivered directly to a QP to allow a client process to support any transport protocol running on top of IPv6. A client process can register with SANIC hardware in order to direct datagrams for a particular upper level protocol (e.g., TCP and UDP) to a particular QP. SANIC hardware can demultiplex incoming IPv6 streams of datagrams based on a next header field as well as the destination IP address.

SANIC and I/O Adapter Endnodes

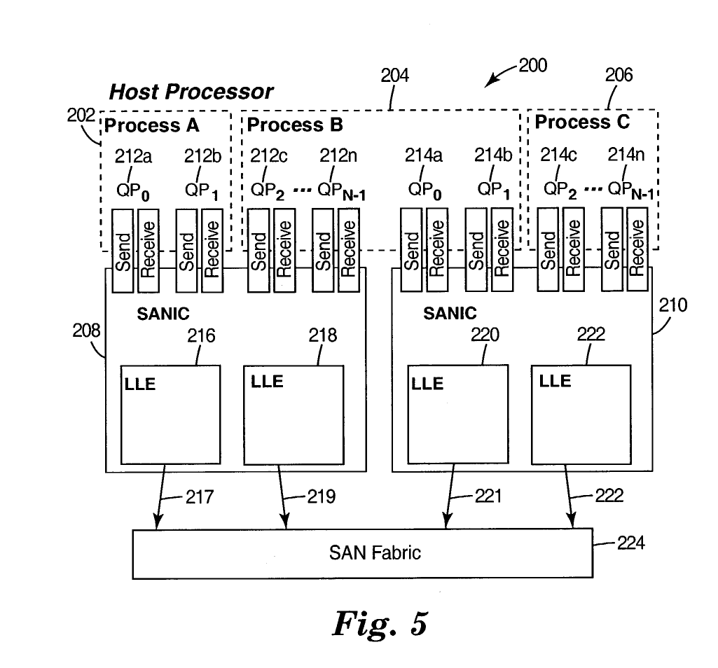

An example host processor node is generally illustrated at 200 in FIG. 5. Host processor node 200 includes a process A indicated at 202, a process B indicated at 204, and a process C indicated at 206. Host processor 200 includes a SANIC 208 and a SANIC 210. As discussed above, a host processor endnode or an I/O adapter endnode can have one or more SANICs. SANIC 208 includes a SAN link level engine (LLE) 216 for communicating with SAN fabric 224 via link 217 and an LLE 218 for communicating with SAN fabric 224 via link 219. SANIC 210 includes an LLE 220 for communicating with SAN fabric 224 via link 221 and an LLE 222 for communicating with SAN fabric 224 via link 223. SANIC 208 communicates with process A indicated at 202 via QPs 212a and 212b. SANIC 208 communicates with process B indicated at 204 via QPs 212c-212n. Thus, SANIC 208 includes N QPs for communicating with processes A and B. SANIC 210 includes QPs 214a and 214b for communicating with process B indicated at 204. SANIC 210 includes QPs 214c-214n for communicating with process C indicated at 206. Thus, SANIC 210 includes N QPs for communicating with processes B and C.

An LLE runs link level protocols to couple a given SANIC to the SAN fabric. RDMA traffic generated by a SANIC can simultaneously employ multiple LLEs within the SANIC which permits striping across LLEs. Striping refers to the dynamic sending of frames within a single message to an endnode's QP through multiple fabric paths. Striping across LLEs increases the bandwidth for a single QP as well as provides multiple fault tolerant paths. Striping also decreases the latency for message transfers. In one embodiment, multiple LLEs in a SANIC are not visible to the client process generating message requests. When a host processor includes multiple SANICs, the client process must explicitly move data on the two SANICs in order to gain parallelism. A single QP cannot be shared by SANICS. Instead a QP is owned by one local SANIC.

The following is an example naming scheme for naming and identifying endnodes in one embodiment of a distributed computer system according to the present invention. A host name provides a logical identification for a host node, such as a host processor node or I/O adapter node. The host name identifies the endpoint for messages such that messages are destine for processes residing on an endnode specified by the host name. Thus, there is one host name per node, but a node can have multiple SANICs.

A globally unique ID (GUID) identifies a transport endpoint. A transport endpoint is the device supporting the transport QPs. There is one GUID associated with each SANIC.

A local ID refers to a short address ID used to identify a SANIC within a single subnet. In one example embodiment, a subnet has up 2¹⁶ endnodes, switches, and routers, and the local ID (LID) is accordingly 16 bits. A source LID (SLID) and a destination LID (DLID) are the source and destination LIDs used in a local network header. A LLE has a single LID associated with the LLE, and the LID is only unique within a given subnet. One or more LIDs can be associated with each SANIC.

An internet protocol (IP) address (e.g., a 128 bit IPv6 ID) addresses a SANIC. The SANIC, however, can have one or more IP addresses associated with the SANIC. The IP address is used in the global network header when routing frames outside of a given subnet. LIDs and IP addresses are network endpoints and are the target of frames routed through the SAN fabric. All IP addresses (e.g., IPv6 addresses) within a subnet share a common set of high order address bits.

In one embodiment, the LLE is not named and is not architecturally visible to a client process. In this embodiment, management software refers to LLEs as an enumerated subset of the SANIC.

Switches and Routers

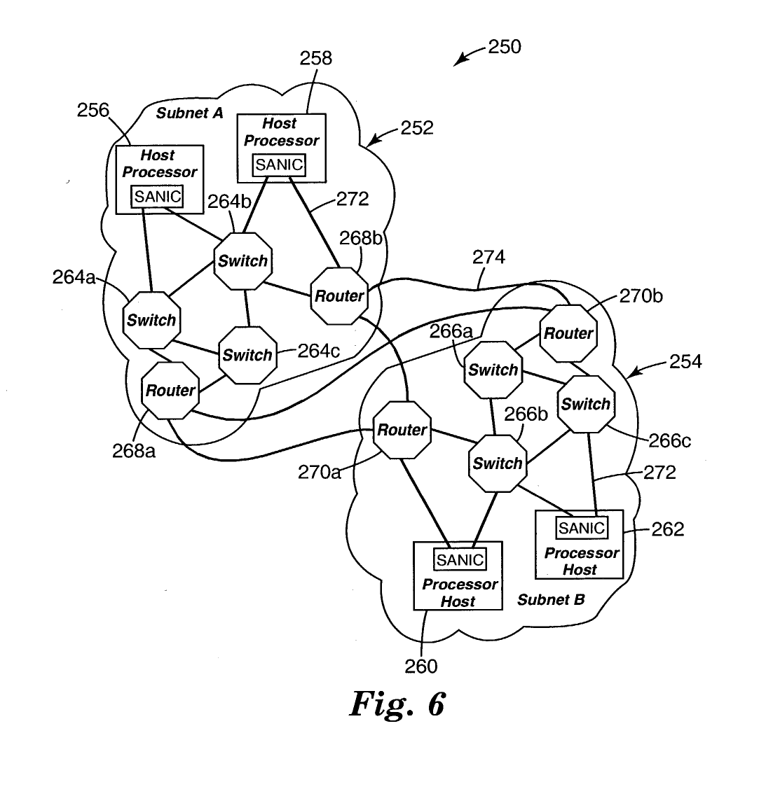

A portion of a distributed computer system is generally illustrated at 250 in/FIG. 6. Distributed computer system 250 includes a subnet A indicated at 252 and a subnet B indicated at 254. Subnet A indicated at 252 includes a host processor node 256 and a host processor node 258. Subnet B indicated at 254 includes a host processor node 260 and host processor node 262. Subnet A indicated at 252 includes switches 264a-264c. Subnet B indicated at 254 includes switches 266a-266c. Each subnet within distributed computer system 250 is connected to other subnets with routers. For example, subnet A indicated at 252 includes routers 268a and 268b which are coupled to routers 270a and 270b of subnet B indicated at 254. In one example embodiment, a subnet has up to 2¹⁶ endnodes, switches, and routers.

A subnet is defined as a group of endnodes and cascaded switches that is managed as a single unit. Typically, a subnet occupies a single geographic or functional area. For example, a single computer system in one room could be defined as a subnet. In one embodiment, the switches in a subnet can perform very fast worm-hole or cut-through routing for messages.

A switch within a subnet examines the DLID that is unique within the subnet to permit the switch to quickly and efficiently route incoming message frames. In one embodiment, the switch is a relatively simple circuit, and is typically implemented as a single integrated circuit. A subnet can have hundreds to thousands of endnodes formed by cascaded switches.

As illustrated in FIG. 6, for expansion to much larger systems, subnets are connected with routers, such as routers 268 and 270. The router interprets the IP destination ID (e.g., IPv6 destination ID) and routes the IP like frame.

In one embodiment, switches and routers degrade when links are over utilized. In this embodiment, link level back pressure is used to temporarily slow the flow of data when multiple input frames compete for a common output. However, link or buffer contention does not cause loss of data. In one embodiment, switches, routers, and endnodes employ a link protocol to transfer data. In one embodiment, the link protocol supports an automatic error retry. In this example embodiment, link level acknowledgments detect errors and force retransmission of any data impacted by bit errors. Link-level error recovery greatly reduces the number of data errors that are handled by the end-to-end protocols. In one embodiment, the user client process is not involved with error recovery no matter if the error is detected and corrected by the link level protocol or the end-to-end protocol.

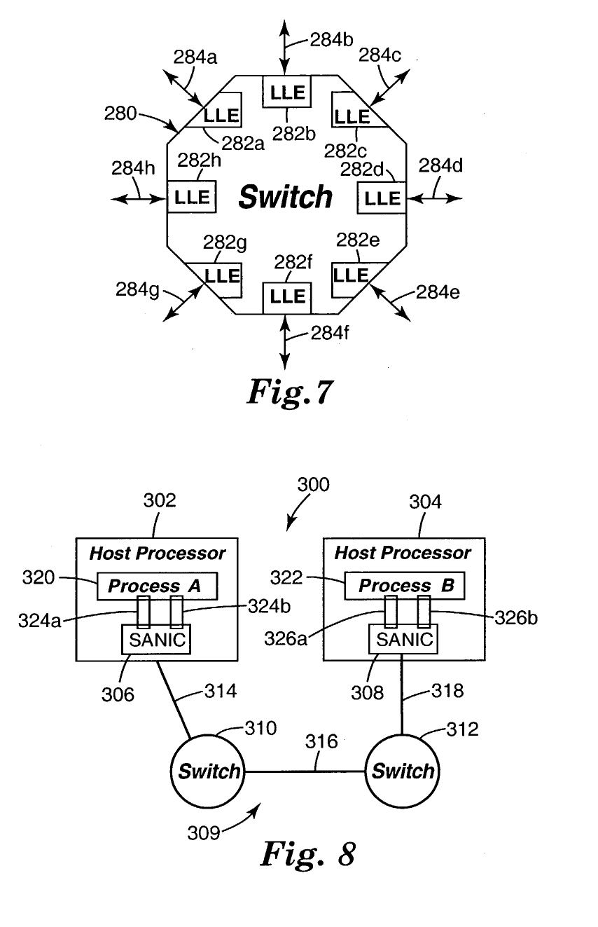

An example embodiment of a switch is generally illustrated at 280 in FIG. 7. Each I/O path on a switch or router has an LLE. For example, switch 280 includes LLEs 282a-282h for communicating respectively with links 284a-284h.

The naming scheme for switches and routers is similar to the above-described naming scheme for endnodes. The following is an example switch and router naming scheme for identifying switches and routers in the SAN fabric. A switch name identifies each switch or group of switches packaged and managed together. Thus, there is a single switch name for each switch or group of switches packaged and managed together.

Each switch or router element has a single unique GUID. Each switch has one or more LIDs and IP addresses (e.g., IPv6 addresses) that are used as an endnode for management frames.

Each LLE is not given an explicit external name in the switch or router. Since links are point-to-point, the other end of the link does not need to address the LLE.

Virtual Lanes

Switches and routers employ multiple virtual lanes within a single physical link. As illustrated in FIG. 6, physical links 272 connect endnodes, switches, and routers within a subnet. WAN or LAN connections 274 typically couple routers between subnets. Frames injected into the SAN fabric follow a particular virtual lane from the frame's source to the frame's destination. At any one time, only one virtual lane makes progress on a given physical link. Virtual lanes provide a technique for applying link level flow control to one virtual lane without affecting the other virtual lanes. When a frame on one virtual lane blocks due to contention, quality of service (QoS), or other considerations, a frame on a different virtual lane is allowed to make progress.

Virtual lanes are employed for numerous reasons, some of which are as follows. Virtual lanes provide QoS. In one example embodiment, certain virtual lanes are reserved for high priority or isonchronous traffic to provide QoS.

Virtual lanes provide deadlock avoidance. Virtual lanes allow topologies that contain loops to send frames across all physical links and still be assured the loops won't cause back pressure dependencies that might result in deadlock.

Virtual lanes alleviate head-of-line blocking. With virtual lanes, a blocked frames can pass a temporarily stalled frame that is destined for a different final destination.

In one embodiment, each switch includes its own crossbar switch. In this embodiment, a switch propagates data from only one frame at a time, per virtual lane through its crossbar switch. In another words, on any one virtual lane, a switch propagates a single frame from start to finish. Thus, in this embodiment, frames are not multiplexed together on a single virtual lane.

Paths in SAN Fabric

Referring to FIG. 6, within a subnet, such as subnet A indicated at 252 or subnet B indicated at 254, a path from a source port to a destination port is determined by the LID of the destination SANIC port. Between subnets, a path is determined by the IP address (e.g., IPv6 address) of the destination SANIC port.

In one embodiment, the paths used by the request frame and the request frame's corresponding positive acknowledgment (ACK) or negative acknowledgment (NAK) frame are not required to be symmetric. In one embodiment employing oblivious routing, switches select an output port based on the DLID. In one embodiment, a switch uses one set of routing decision criteria for all its input ports. In one example embodiment, the routing decision criteria is contained in one routing table. In an alternative embodiment, a switch employs a separate set of criteria for each input port.

Each port on an endnode can have multiple IP addresses. Multiple IP addresses can be used for several reasons, some of which are provided by the following examples. In one embodiment, different IP addresses identify different partitions or services on an endnode. In one embodiment, different IP addresses are used to specify different QoS attributes. In one embodiment, different IP addresses identify different paths through intra-subnet routes.

In one embodiment, each port on an endnode can have multiple LIDs. Multiple LIDs can be used for several reasons some of which are provided by the following examples. In one embodiment, different LIDs identify different partitions or services on an endnode. In one embodiment, different LIDs are used to specify different QoS attributes. In one embodiment, different LIDs specify different paths through the subnet.

A one-to-one correspondence does not necessarily exist between LIDs and IP addresses, because a SANIC can have more or less LIDs than IP addresses for each port. For SANICs with redundant ports and redundant conductivity to multiple SAN fabrics, SANICs can, but are not required to, use the same LID and IP address on each of its ports.

Data Transactions

Referring to FIG. 1, a data transaction in distributed computer system 30 is typically composed of several hardware and software steps. A client process of a data transport service can be a user-mode or a kernel-mode process. The client process accesses SANIC 42 hardware through one or more QPs, such as QPs 64 illustrated in FIG. 2. The client process calls an operating-system specific programming interface which is herein referred to as verbs. The software code implementing the verbs intern posts a WQE to the given QP work queue.

There are many possible methods of posting a WQE and there are many possible WQE formats, which allow for various cost/performance design points, but which do not affect interoperability. A user process, however, must communicate to verbs in a well-defined manner, and the format and protocols of data transmitted across the SAN fabric must be sufficiently specified to allow devices to interoperate in a heterogeneous vendor environment.

In one embodiment, SANIC hardware detects WQE posting and accesses the WQE. In this embodiment, the SANIC hardware translates and validates the WQEs virtual addresses and accesses the data. In one embodiment, an outgoing message buffer is split into one or more frames. In one embodiment, the SANIC hardware adds a transport header and a network header to each frame. The transport header includes sequence numbers and other transport information. The network header includes the destination IP address or the DLID or other suitable destination address information. The appropriate local or global network header is added to a given frame depending on if the destination endnode resides on the local subnet or on a remote subnet.

A frame is a unit of information that is routed through the SAN fabric. The frame is an endnode-to-endnode construct, and is thus created and consumed by endnodes. Switches and routers neither generate nor consume request frames or acknowledgment frames. Instead switches and routers simply move request frames or acknowledgment frames closer to the ultimate destination. Routers, however, modify the frame's network header when the frame crosses a subnet boundary. In traversing a subnet, a single frame stays on a single virtual lane.

When a frame is placed onto a link, the frame is further broken down into flits. A flit is herein defined to be a unit of link-level flow control and is a unit of transfer employed only on a point-to-point link. The flow of flits is subject to the link-level protocol which can perform flow control or retransmission after an error. Thus, flit is a link-level construct that is created at each endnode, switch, or router output port and consumed at each input port. In one embodiment, a flit contains a header with virtual lane error checking information, size information, and reverse channel credit information.

If a reliable transport service is employed, after a request frame reaches its destination endnode, the destination endnode sends an acknowledgment frame back to the sender endnode. The acknowledgment frame permits the requester to validate that the request frame reached the destination endnode. An acknowledgment frame is sent back to the requester after each request frame. The requestor can have multiple outstanding requests before it receives any acknowledgments. In one embodiment, the number of multiple outstanding requests is determined when a QP is created.

Example Request and Acknowledgment Transactions

FIGS. 8, 9A, 9B, 10A, and 10B together illustrate example request and acknowledgment transactions. In FIG. 8, a portion of a distributed computer system is generally illustrated at 300. Distributed computer system 300 includes a host processor node 302 and a host processor node 304. Host processor node 302 includes a SANIC 306. Host processor node 304 includes a SANIC 308. Distributed computer system 300 includes a SAN fabric 309 which includes a switch 310 and a switch 312. SAN fabric 309 includes a link 314 coupling SANIC 306 to switch 310; a link 316 coupling switch 310 to switch 312; and a link 318 coupling SANIC 308 to switch 312.

In the example transactions, host processor node 302 includes a client process A indicated at 320. Host processor node 304 includes a client process B indicated at 322. Client process 320 interacts with SANIC hardware 306 through QP 324. Client process 322 interacts with SANIC hardware 308 through QP 326. QP 324 and 326 are software data structures. QP 324 includes send work queue 324a and receive work queue 324b. QP 326 includes send work queue 326a and receive work queue 326b.

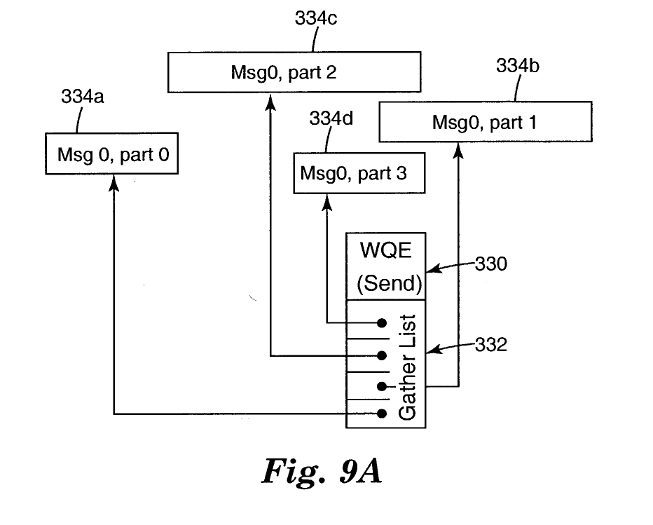

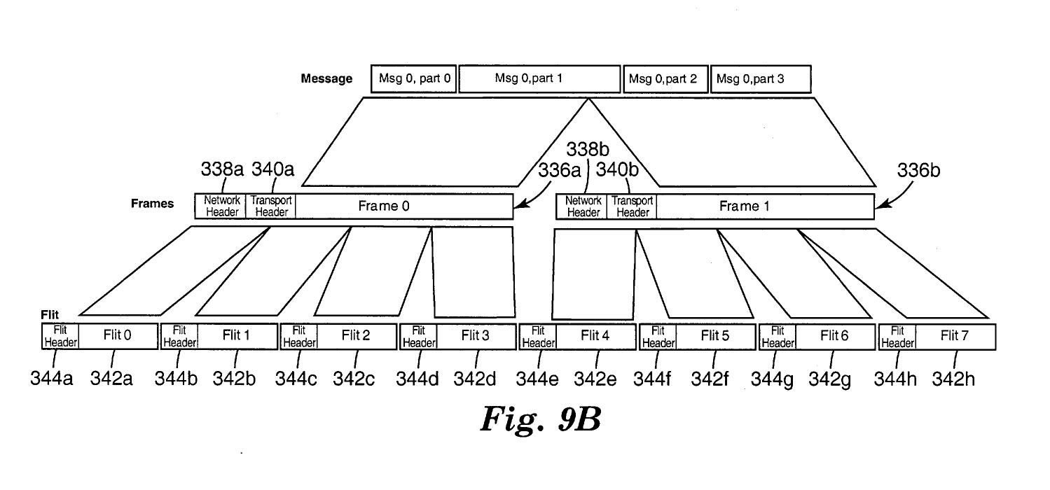

Process 320 initiates a message request by posting WQEs to send work queue 324a. Such a WQE is illustrated at 330 in FIG. 9A. The message request of client process 320 is referenced by a gather list 332 contained in send WQE 330. Each entry in gather list 332 points to a virtually contiguous buffer in the local memory space containing a part of the message, such as indicated by virtual contiguous buffers 334a-334d, which respectively hold message 0, parts 0, 1, 2, and 3.

Referring to FIG. 9B, hardware in SANIC 306 reads WQE 330 and packetizes the message stored in virtual contiguous buffers 334a-334d into frames and flits. As illustrated in FIG. 9B, all of message 0, part 0 and a portion of message 0, part 1 are packetized into frame 0, indicated at 336a. The rest of message 0, part 1 and all of message 0, part 2, and all of message 0, part 3 are packetized into frame 1, indicated at 336b. Frame 0 indicated at 336a includes network header 338a and transport header 340a. Frame 1 indicated at 336b includes network header 338b and transport header 340b.

As indicated in FIG. 9B, frame 0 indicated at 336a is partitioned into flits 0-3, indicated respectively at 342a-342d. Frame 1 indicated at 336b is partitioned into flits 4-7 indicated respectively at 342e-342h. Flits 342a through 342h respectively include flit headers 344a-344h.

Frames are routed through the SAN fabric, and for reliable transfer services, are acknowledged by the final destination endnode. If not successfully acknowledged, the frame is retransmitted by the source endnode. Frames are generated by source endnodes and consumed by destination endnodes. The switches and routers in the SAN fabric neither generate nor consume frames.

Flits are the smallest unit of flow control in the network. Flits are generated and consumed at each end of a physical link. Flits are acknowledged at the receiving end of each link and are retransmitted in response to an error. For example, controlling retransmission or abortion of flit transmission can be accomplished with each sender maintaining a per-port link retry timer to monitor the time between flit transmission and receipt acknowledgment. If the link retry timer expires, the sender attempts to retry transmission of the outstanding flit. A second timer, called a link kill timer, is active while the sender is operating in a retry mode. On expiration of the link kill timer, transmission is aborted.

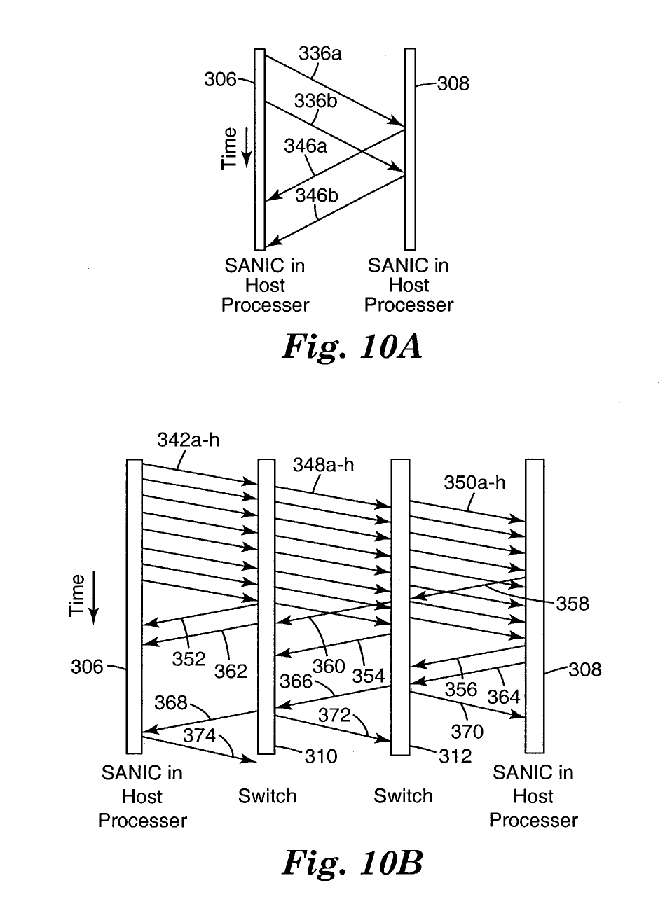

Referring to FIG. 10A, the send request message 0 is transmitted from SANIC 306 in host processor node 302 to SANIC 308 in host processor node 304 as frames 0 indicated at 336a and frame 1 indicated at 336b. ACK frames 346a and 346b, corresponding respectively to request frames 336a and 336b, are transmitted from SANIC 308 in host processor node 304 to SANIC 306 in host processor node 302.

In FIG. 10A, message 0 is being transmitted with a reliable transport service. Each request frame is individually acknowledged by the destination endnode (e.g., SANIC 308 in host processor node 304).

FIG. 10B illustrates the flits associated with the request frames 336 and acknowledgment frames 346 illustrated in FIG. 10A passing between the host processor endnodes 302 and 304 and the switches 310 and 312. As illustrated in FIG. 10B, an ACK frame fits inside one flit. In one embodiment, one acknowledgment flit acknowledges several flits.

As illustrated in FIG. 10B, flits 342a-h are transmitted from SANIC 306 to switch 310. Switch 310 consumes flits 342a-h at its input port, creates flits 348a-h at its output port corresponding to flits 342a-h, and transmits flits 348a-h to switch 312. Switch 312 consumes flits 348a-h at its input port, creates flits 350a-h at its output port corresponding to flits 348a-h, and transmits flits 350a-h to SANIC 308. SANIC 308 consumes flits 350a-h at its input port. An acknowledgment flit is transmitted from switch 310 to SANIC 306 to acknowledge the receipt of flits 342a-h. An acknowledgment flit 354 is transmitted from switch 312 to switch 310 to acknowledge the receipt of flits 348a-h. An acknowledgment flit 356 is transmitted from SANIC 308 to switch 312 to acknowledge the receipt of flits 350a-h.

Acknowledgment frame 346a fits inside of flit 358 which is transmitted from SANIC 308 to switch 312. Switch 312 consumes flits 358 at its input port, creates flit 360 corresponding to flit 358 at its output port, and transmits flit 360 to switch 310. Switch 310 consumes flit 360 at its input port, creates flit 362 corresponding to flit 360 at its output port, and transmits flit 362 to SANIC 306. SANIC 306 consumes flit 362 at its input port. Similarly, SANIC 308 transmits acknowledgment frame 346b in flit 364 to switch 312. Switch 312 creates flit 366 corresponding to flit 364, and transmits flit 366 to switch 310. Switch 310 creates flit 368 corresponding to flit 366, and transmits flit 368 to SANIC 306.

Switch 312 acknowledges the receipt of flits 358 and 364 with acknowledgment flit 370, which is transmitted from switch 312 to SANIC 308. Switch 310 acknowledges the receipt of flits 360 and 366 with acknowledgment flit 372, which is transmitted to switch 312. SANIC 306 acknowledges the receipt of flits 362 and 368 with acknowledgment flit 374 which is transmitted to switch 310.

Architecture Layers and Implementation Overview

A host processor endnode and an I/O adapter endnode typically have quite different capabilities. For example, an example host processor endnode might support four ports, hundreds to thousands of QPs, and allow incoming RDMA operations, while an attached I/O adapter endnode might only support one or two ports, tens of QPs, and not allow incoming RDMA operations. A low-end attached I/O adapter alternatively can employ software to handle much of the network and transport layer functionality which is performed in hardware (e.g., by SANIC hardware) at the host processor endnode.

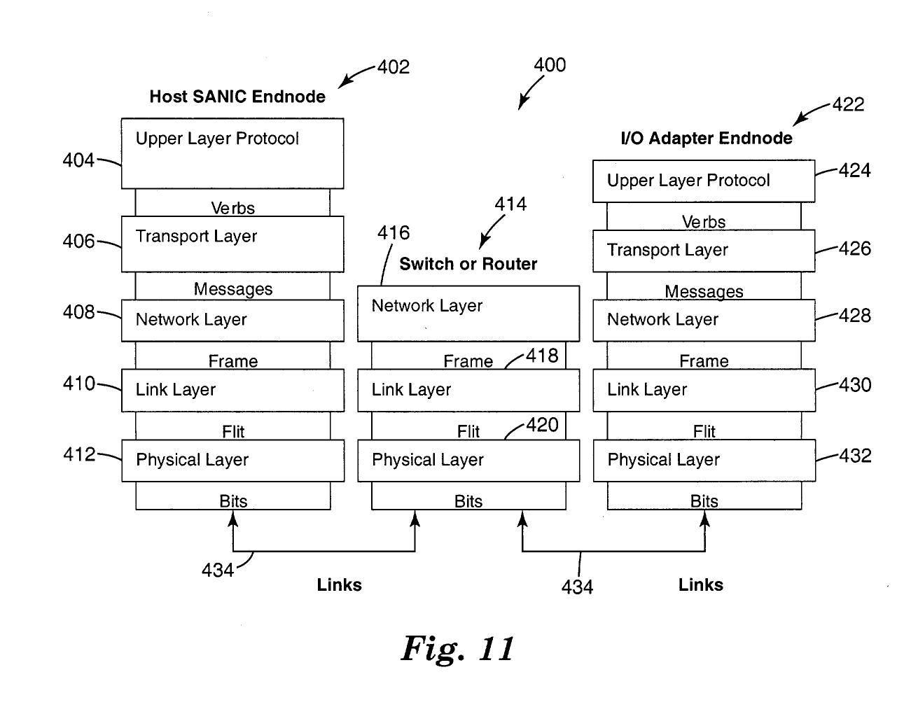

One embodiment of a layered architecture for implementing the present invention is generally illustrated at 400 in diagram form in FIG. 11. The layered architecture diagram of FIG. 11 shows the various layers of data communication paths, and organization of data and control information passed between layers.

Host SANIC endnode layers are generally indicated at 402. The host SANIC endnode layers 402 include an upper layer protocol 404; a transport layer 406; a network layer 408; a link layer 410; and a physical layer 412.

Switch or router layers are generally indicated at 414. Switch or router layers 414 include a network layer 416; a link layer 418; and a physical layer 420.

I/O adapter endnode layers are generally indicated at 422. I/O adapter endnode layers 422 include an upper layer protocol 424; a transport layer 426; a network layer 428; a link layer 430; and a physical layer 432.

The layered architecture 400 generally follows an outline of a classical communication stack. The upper layer protocols employ verbs to create messages at the transport layers. The transport layers pass messages to the network layers. The network layers pass frames down to the link layers. The link layers pass flits through physical layers. The physical layers send bits or groups of bits to other physical layers. Similarly, the link layers pass flits to other link layers, and don't have visibility to how the physical layer bit transmission is actually accomplished. The network layers only handle frame routing, without visibility to segmentation and reassembly of frames into flits or transmission between link layers.

Bits or groups of bits are passed between physical layers via links 434. Links 434 can be implemented with printed circuit copper traces, copper cable, optical cable, or with other suitable links.

The upper layer protocol layers are applications or processes which employ the other layers for communicating between endnodes.

The transport layers provide end-to-end message movement. In one embodiment, the transport layers provide four types of transport services as described above which are reliable connection service; reliable datagram service; unreliable datagram service; and raw datagram service.

The network layers perform frame routing through a subnet or multiple subnets to destination endnodes.

The link layers perform flow-controlled, error controlled, and prioritized frame delivery across links.

The physical layers perform technology-dependent bit transmission and reassembly into flits.

Congestion Management

If a network is properly provisioned and the topology is well understood and controlled, network traffic will make forward progress under most operating workloads (albeit at reduced operating efficiency) assuming that network end nodes are consuming their inbound frames, and thus generally avoiding back pressure. However, at very high speeds, or in a network with variable speed link elements and/or topologies, the overall network efficiency and application effective throughput can drop to the point where the network appears to be down, even while network traffic is not in a condition of deadlock per se.

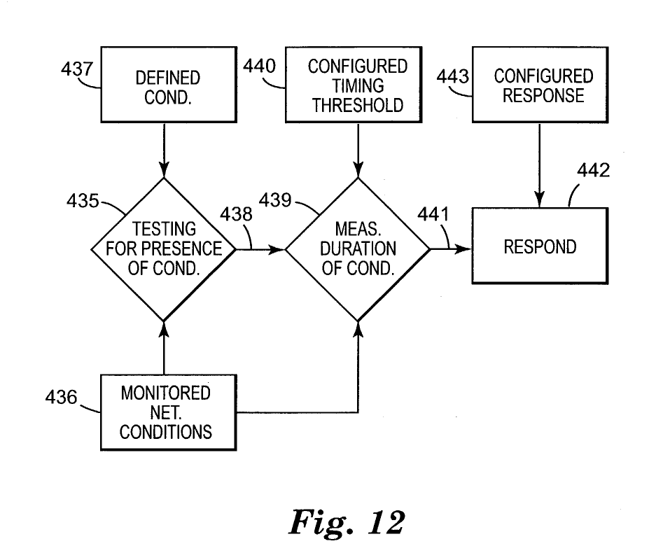

An example embodiment of a method for recognizing and managing network system congestion using congestion detection, reporting, and responding mechanisms is illustrated in FIG. 12. The method involves monitoring network traffic conditions for signs of inefficiency, or network bandwidth underutilization. At 435, monitored network conditions 436 are tested for the presence of certain conditions indicative of delayed frame transmission progress, defined at 437. The result of the testing at 435 is indicated at 438. At 439, based on test result 438, the duration of monitored conditions 436 is timed and compared to a configured timing threshold 440. At 441, an indication is provided if, at 439, the measured duration of monitored conditions 436 exceeds configured timing threshold 440. A response 442 is made based on indication 441 and on response configuration 443.

One embodiment of measurement mechanism 439 is implemented in a network end station, such as an end node or routing device, that includes one or more aggressive timers for indicating a delay in frame transmission. An aggressive timer is herein defined as a timing device or mechanism that monitors the transmission of information in a network system or network system element, and can be configured to provide an indication of whether and when the transmission of information fails to meet at least one variable timing threshold. An aggressive timer can be implemented in hardware or software.

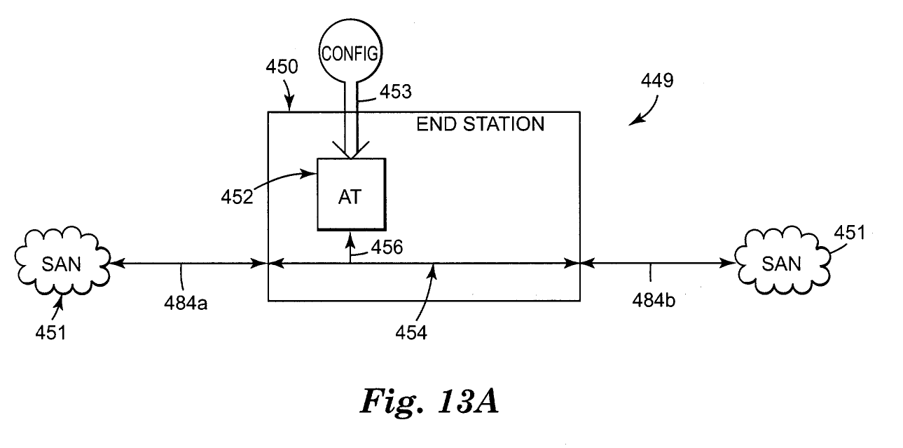

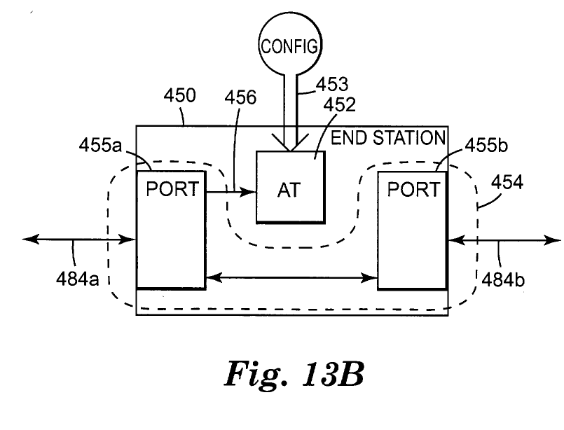

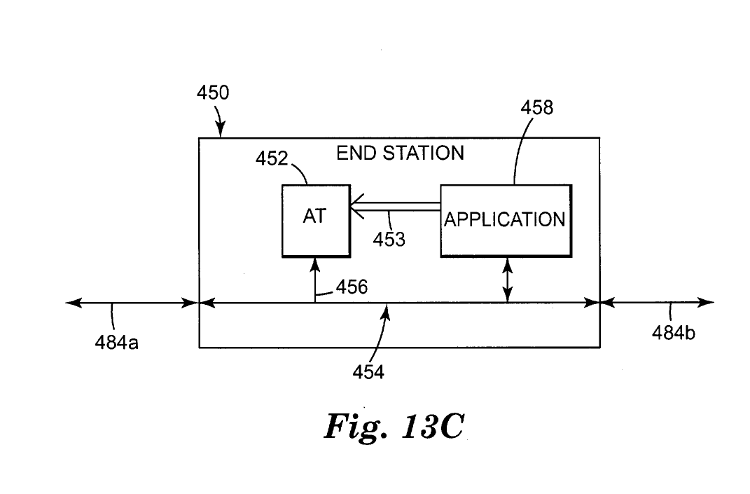

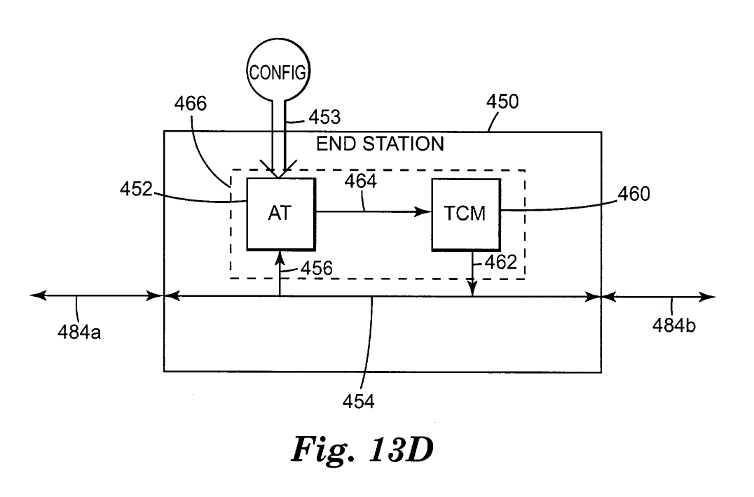

One embodiment of a network system is illustrated generally at 449 in FIG. 13A. Network system 449 includes an end station 450 comprising aggressive timer 452. End station 450 interfaces with other end stations of SAN 451 through links 484a and 484b. Network traffic internal to end station 450 is indicated at 454. Aggressive timer 452 monitors network traffic 454 via a monitoring mechanism 456.

Aggressive timer 452's variable timing threshold is configurable and re-configurable as a function of network system attributes, as indicated at 453. An attribute of an entity is herein defined as including, but not limited to, at least one aspect, characteristic, condition, configuration, essence, parameter, property, quality, setting, or status, of the entity to which it refers. Aggressive timer 452 sufficiently monitors network traffic to permit its variable timing threshold to be configured to detect or anticipate the onset of congestion. Aggressive timer 452's variable timing threshold is configurable and re-configurable to accommodate different network circumstances, such as variations in network system attributes, including frame attributes and operating conditions within the network system.

The variable timing threshold of the aggressive timer 452 refers to a duration of time against which one or more defined conditions of delayed frame transmission progress can be compared. The conditions of delayed frame transmission progress can be defined in a number of ways according to network traffic management policy. For example, in one embodiment, an expiration of a link retry timer is a condition of delayed frame transmission progress. In one embodiment, the variable timing threshold is varied from one configuration to another by setting a starting count, ending count and/or counting rate. In one embodiment, the variable timing threshold is varied by adjusting a timing interval having a configurable ending time relative to a starting time. In one embodiment, the variable timing threshold is configurable to enable or disable the aggressive timer. When the variable timing threshold is exceeded, numerous suitable responses can be taken as part of enforcing a congestion management policy.

FIG. 13B illustrates an exemplary end station 450 according to one embodiment of the present invention, which includes an aggressive timer 452. The Aggressive timer 452 is adapted to monitor one or more ports 455 of end station 450. In one embodiment, aggressive timer 452 measures whether the transmission of a frame has stalled for a time that exceeds the variable timing threshold. In one embodiment, a variable timing threshold's duration is only slightly longer than the time needed for transmitting a given frame out of a port 455 under normal operating conditions. Such a short time limit facilitates fast recognition of transmission delay, which permits anticipation of network congestion. In one embodiment, the aggressive timer has microsecond granularity.

In one embodiment, aggressive timer 452 is implemented in end station 450 as a count-down timer set to a specific counting value and counting rate, which together, represent the configured variable timing threshold. In this embodiment, count down aggressive timer 452 counts down during one or more defined conditions of delayed frame transmission progress, such as a period of transmission delay associated with a port 455. In one form of this embodiment, the frame transmission delay is defined by an indication of the output frame's failure to make forward progress. If the frame makes forward progress, count-down aggressive timer 452 is reset. In another form of this embodiment, the count-down aggressive timer 452 is set to count while any part of a frame remains in a transmit register, regardless of forward progress status.

In one embodiment, the variable timing threshold is configured by an appropriate authority, such as network fabric management. In an alternative embodiment, the variable timing threshold is dynamically configurable, either manually or by program, based on potentially changing circumstances or decision-making criteria relating to the network system. Examples of potentially changing network circumstances include network system attributes, such as a congestion level of an end station's port, a policy for managing network congestion, or various attributes of a frame to be transmitted.

An exemplary potentially changing decision-making criteria relating to the network system, is a congestion management policy instituted by network fabric management. Network circumstances and decision-making criteria can also be interrelated, such that a congestion management policy, for example, can change in response to changing network system conditions. The dynamic characteristics of embodiments of the present invention can be employed to implement potentially changing network decision-making criteria, measuring potentially changing network circumstances, or both.

One embodiment of aggressive timer 452 is configurable based on one or more network system attributes. In this embodiment, configuration of the variable timing threshold can be made based on one or more predetermined network system attributes and/or based on measured network system status. Predetermined network system attributes herein refers to information characterizing at least one aspect of the network system and its contents that was determined at some time before the period surrounding the setting of the variable timing threshold, or over a period of time prior to, and potentially including, the decision-making period. Measured network system status, on the other hand, refers to at least one aspect of the network system and its contents that is determined in the period surrounding the setting of the variable timing threshold. The variable timing threshold can be dynamically configurable in embodiments of aggressive timer 452 having a variable timing threshold based on predetermined or measured network system attributes.

In some embodiments, aggressive timer 452 is configurable based on one or more attributes of at least one port 455. In one such embodiment, the aggressive timer 452's variable timing threshold is adjustable as a function of a measured presence of back pressure from a port. Back pressure herein refers to network operation that is indicative of insufficient buffer space. In another such embodiment, the variable timing threshold is based on historical data of a port's back pressure occurrences over a period of time. In one example operation of end station 450 of FIG. 13B, port 455a tends to be congested, and end station 450 accordingly institutes a more stringent variable timing threshold for congestion management.

In one embodiment, the variable timing threshold is configurable based on the type of workload of applications utilizing the network system. FIG. 13C illustrates an end station 450, which runs an application 458. Aggressive timer 452's variable timing threshold is configurable based on the type of workload of application 458. Workload herein refers to the information exchanged over the network for a given application. Example types of workloads include digital video information for video applications, and file transfer protocol (FTP). Since video workloads are less tolerant of inconsistent transmission rates, an exemplary congestion management policy can impose variable timing thresholds with shorter limits for video applications than for web page browsing applications. In one embodiment, a network system which predominately carries video application data, comprises end stations 450 with aggressive timers 452 configured with stringent variable timing thresholds for early detection and prevention of congestion.

In one embodiment, the variable timing threshold is configurable based on an amount of time one or more frames fails to make forward progress. In one embodiment, end station 450 employs aggressive timer 452 to measure congestion experienced by a first frame targeting a particular port 455. In one example of this embodiment, the aggressive timer 452 is set to expire after a time period that is approximately the time needed to transmit the first frame to its targeted port 455 in the absence of congestion. In one embodiment, end station 450 is further configured to track the number of frame delay indications of aggressive timer 452, as applied to the first frame. If the frame is delayed due to congestion, aggressive timer 452 provides at least one frame delay indication. In this embodiment, the tracked number of frame delay indications represents an amount of time during which the frame fails to make forward progress. In this embodiment, the variable timing threshold for identifying a level of congestion that requires a response, is represented by a number of aggressive timer 452 expirations. The variable timing threshold for a second frame targeting the same port 455 can be adjusted based on the number.

In one embodiment, the variable timing threshold is configurable based on the type of network system architecture. In some embodiments, an end station 450 transmitting a frame employs predetermined information about at least one end station along the frame's intended transmission path to configure the variable timing threshold for the frame. In one such embodiment, the predetermined information includes the at least one end station's role in overall system performance. For example, if a first frame's routing path includes a switch that is a major network hub and potential bottleneck, the variable timing threshold for the first frame can be set to be more stringent.

In another embodiment, the variable timing threshold is configurable based on historical data of the congestion status of the end stations along a frame's routing path. In another embodiment, the variable timing threshold is based on a measured congestion status of an end station along the routing path. In another embodiment, the variable timer threshold is configurable based on a predetermined or measured transmission bandwidth of at least one downstream end station. The bandwidth might be restricted due to the end stations' capacity or congestion status. In an example of such an embodiment, a variable timing threshold of an aggressive timer 452 used with a port 455 is a function of the associated link hop speed.

In some embodiments, the variable timing threshold is based on a frame attribute. In one such embodiment, the frame upon which the threshold is based is examined to ascertain its relevant attributes. In this embodiment, the end station 450 includes a hardware or software mechanism for examining a frame's protocol header and/or trailer. In another embodiment, the variable timing threshold is based on the size of a frame. In one form of this embodiment, the aggressive timer 452 is configured to a limit that is proportional to the size of the frame in the transmit register of port 455. A limit that is only slightly greater than the time for transmitting the frame, provides a high sensitivity for detecting transmission delay.

In another embodiment, the variable timing threshold is configurable based on the output frame's information type, such as whether the frame carries data or control information. In one such embodiment, the information type is determined using a mechanism for parsing out a message's opcode. Depending on a policy for managing congestion in a distributed computer system, control frames can be given a higher or lower priority of service than data-bearing frames, such that the aggressive timer 452 is configured to allow higher priority frames more time to make forward progress before a congestion management response is taken with respect to the frames.

In some embodiments, the variable timing threshold is dynamically configurable based on a frame's source or destination end station. In one such embodiment, the aggressive timer 452 is configured based on the frame's final destination end station. In this embodiment, the end station 450 transmitting the frame examines the frame to determine its final destination, and configures the variable timing threshold of aggressive timer 452 accordingly. In one example embodiment, a frame addressed to an inherently slower device, such as a disk drive, is subject to a more stringent timing threshold (i.e., a shorter time limit) than a frame addressed to a faster device, such as a video output device. In this embodiment, the transmitting end station 450 has a mechanism to recognize the final destination end station type with respect to its role on system performance. Therefore, an exemplary transmitting end station, utilizing aggressive timing configured based on final frame destination, can enforce a priority policy that gives service precedence to frames destined for end station types that have more time-critical roles.

In one embodiment, the variable timing threshold is based on the source end station of a given frame. Network system policy may have assigned a higher or lower priority for frames originating from particular end nodes. Thus, an exemplary transmitting end station 450 along the frame's routing path examines the frame header to determine the originating end node, looks up the variable timing threshold for the end node, and applies the variable timing threshold as a time limit for the aggressive timer 452.

In another embodiment where the variable timing threshold for an aggressive timer is configurable based on one or more frame attributes, the frame being transported is examined for its group identification, which is indicative of the type of communication service of the frame. Example communication service types include, but are not limited to: multicasting, unicasting, and broadcasting. An exemplary embodiment of this type implements one or more policies for congestion management or priority servicing, where the policy dictates various priorities for respective communication services. In one such embodiment, the variable timing threshold is applied frame-by-frame according to each frame's communication service. For example, in a network system where a policy provides higher priority to multicast transmissions, end stations 450 along a routing path for a given multicast frame, apply less stringent timing thresholds (longer aggressive timer limits) to the multicast frame.

In one type of embodiment, the variable timing threshold is configurable based on a frame's assigned service level. In one such embodiment, the end station 450 examines the frame to be transmitted to determine its service level flag values. Depending on the frame's priority, the variable timing threshold is configured to be more or less stringent. In an exemplary embodiment, an aggressive timing limit for a low-priority frame is set to a lower, more stringent level, to cause the low-priority frame to not be transmitted in favor of preserving transmission bandwidth for higher-priority frames.

Upon expiration of the aggressive timer 452, an exemplary end station 450 takes one or more actions in response thereto. In one embodiment, as illustrated in FIG. 13D, the end station 450 includes a traffic congestion manager 460 for responding to the aggressive timer 452's indication of its expiration. Traffic congestion manager 460's response is denoted at 462; aggressive timer 452's indication is denoted at 464. The traffic congestion manager 460 can be realized in hardware or software. In one configuration, a traffic congestion manager and at least one aggressive timer are realized as a single functional unit 466, which performs the functions of both the aggressive timer and traffic congestion manager.

In some embodiments, the traffic congestion manager 460 is configurable to respond to the aggressive timer 452's indication in a number of ways. In one such embodiment, the traffic congestion manager responds to an expiration of the aggressive timer 452 by dropping at least one frame. In one exemplary embodiment, the traffic congestion manager 460 drops the frame currently being transmitted. In another exemplary embodiment, the traffic congestion manager 460 drops frames randomly, or by a weighted random algorithm. In another exemplary embodiment, the traffic congestion manager 460 drops one or more frames in a port's transmission buffer based on the frames' attributes. For example, traffic congestion manager 460 drops all frames in the output buffer targeting the same intermediate or final destination end station that the current frame targets when the aggressive timer 452 measuring the current frame's transmission progress expires. In another example, the traffic congestion manager 460 clears the entire transmit buffer of the port in response to aggressive timer 452's expiration. In one type of embodiment, the frame dropping is performed over a certain period of time in order to affect future frames as well as the current frame.

In an embodiment of a traffic congestion manager 460, upon expiration of the aggressive timer 452, congestion manager 460 truncates the current frame by discarding the frame's untransmitted flits. In another embodiment, the traffic congestion manager 460 responds to an expiration of aggressive timer 452 by generating one or more reporting frames to be used by one or more end stations or fabric management for congestion management purposes. An exemplary reporting frame includes data characterizing the nature of the aggressive timer's expiration, or circumstances surrounding the aggressive timer's expiration. In one embodiment, the reporting frame has data containing information about the delayed frame during the transmission of which the aggressive timer 452 expired, such as the frame's size, destination, or service level.

In another type of embodiment, the traffic congestion manager 460 responds to aggressive timer 452's expiration by tagging the current frame with information indicative of the congestion experienced by the frame. In one such embodiment, the current frame and all subsequent frames thereto are tagged for a period of time. Tagging can thus be used as a means for communicating traffic congestion information to other end stations in the network. The other end stations can include fabric management agents, neighboring routing elements, and source endnodes.

In another type of embodiment, the traffic congestion manager 460 responds to the aggressive timer 452's expiration by logging the expiration occurrence and its surrounding circumstances. One such embodiment of traffic congestion manager 460 maintains a log of aggressive timer 452 expirations, wherein the log contains information useful for characterizing the end station 450's congestion status over a period time. In one embodiment, this characterization is employed to re-configure at least one aggressive timer 452's variable timing threshold.

In one type of embodiment, the traffic congestion manager 460 is dynamically configurable. In one such embodiment, the response to the aggressive timer 452 is selectable by network system or fabric management. In other embodiments, the response is dynamically configurable based on predetermined or measured changing circumstances, as described above for the dynamically configurable aggressive timer.

In another embodiment, the response 462 is configurable based on one or more frame delay indications 464 provided by the aggressive timer 452. For example, in an implementation where the aggressive timer is configured to indicate multiple levels of delay (such as with a plurality of frame transmission delay indications), the traffic congestion manager 460 can take different responses as the frame delay continues. The responses 462 can progressively increase in their efficacy as a measured delay becomes longer. In an exemplary configuration, the initial response 462 is a type of event logging; the next response 462 is communication of congestion status (such as frame tagging or sending congestion management packets); the next response 462 is a type of selective frame dropping; finally, the most drastic response 462 to aggressive timer expiration is a flushing of all buffered frames for a period of time.

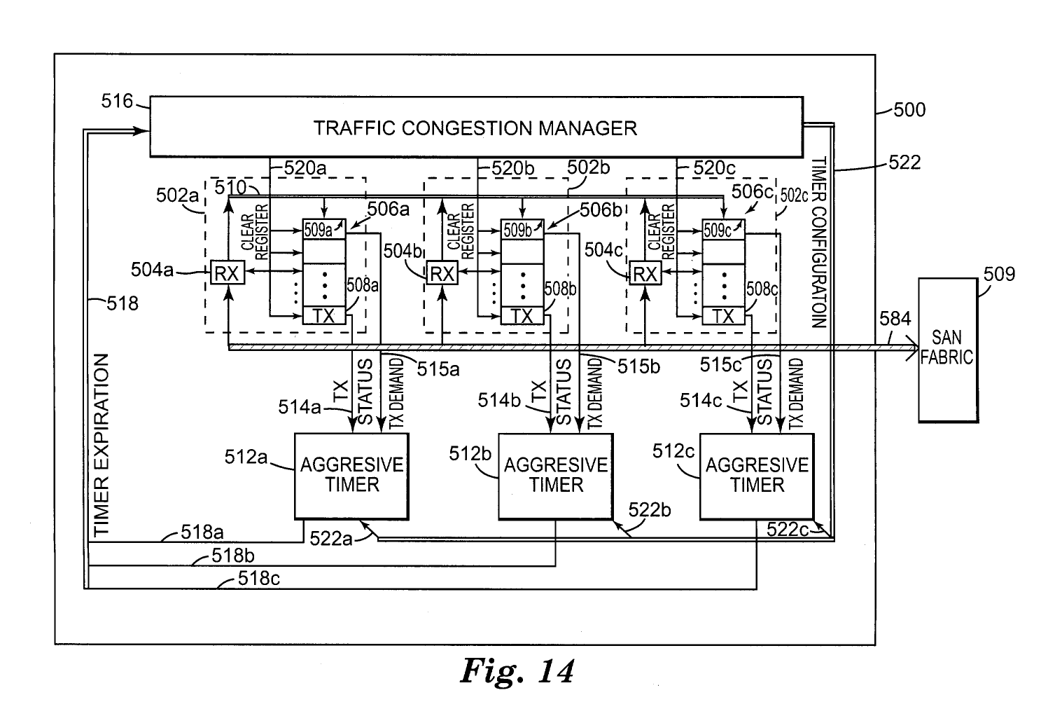

FIG. 14 illustrates an exemplary routing element 500 interfacing with SAN fabric 509 through a link indicated generally at 584. Routing element 500 includes ports 502a, 502b and 502c. Ports 502 connect via links 584a, 584b and 584c, respectively, with SAN fabric 509. Each port 502 has a receive register 504 and transmit queue 506. Transmit queues 506 include head-of-line transmit registers 508, and back-of-line queue input registers 509. Receive registers 504 and transmit registers 508 connect to link 284.

Bus 510 provides an interface for receive registers 504 and queue input registers 509 to exchange frames within the routing element 500. Receive registers 504 interface with a bus 510 that facilitates communication with the two transmit queues 506 from the two other ports. Each queue input register 509 interfaces with the two receive registers 504 from the two other ports via bus 510.

To illustrate a switching operation of routing element 500, consider an exemplary incoming frame to routing element 500 arriving to port 502a, and which is to be transmitted out through port 502c. The incoming frame arrives to port 502a's receive register 504a via link 584. The frame then passes into transmit queue 506c through queue input register 509c via bus 510. As transmit queue 506c transmits previous frames out through transmit register 508c, the frame advances until it reaches transmit register 508c. Finally, the frame is transmitted from transmit register 508c via link 584 into SAN fabric 309 on its way to its final destination.

Exemplary routing element 500 also includes per-port aggressive timers 512a, 512b and 512c, and traffic congestion manager 516. Aggressive timers 512 and traffic congestion manager 516 are components of a local network traffic congestion management system for implementing traffic congestion management policies. Each aggressive timer 512 monitors the transmission status 514 of each corresponding transmission register 508. Transmission status 514 is indicative of frame transmission progress, such as whether flits of the transmitted frame are being sent. In another configuration, transmission status 514 is simply an indicator of when a new frame enters transmit register 508. Timers 512 also monitor transmission demand 515 for each corresponding port 502. The transmission demand 515 of each port 502 is indicative of each port's pending outgoing traffic volume. For example, transmission demand 515 provides a signal whenever the corresponding queue input register 509 receives a new frame.

Each aggressive timer 512 measures the presence of any transmission delay of frames in its corresponding transmit register 508. The measurement is based on one or more variable timing threshold(s) with which each aggressive timer 512 is configured. As discussed above, the variable timing thresholds themselves can be based on a variety of attributes, parameters, or attributes relating to the network system, including one or more frames. In the present example, a variable timing threshold is provided to each aggressive timer 512 by traffic congestion manager 516 via a timer configuration signal, indicated at 522. Timer configuration signal 522 can be supplied continuously, periodically, or occasionally to dynamically configure the aggressive timers 512. Each aggressive timer 512 can have a unique configuration signal, as indicated at 522a, 522b and 522c.

If a measured transmission delay exceeds the configured variable timing threshold of an aggressive timer 512, the aggressive timer 512 will provide a timer expiration indication 518 to traffic congestion manager 516. Traffic congestion manager 516 can then take an appropriate response according to the traffic management policy instituted. Responses include a variety of actions, some of which are described above. One such action is dropping one or more frames from a congested port 502. Frames can be dropped selectively, based on one or more frame attributes. In the present example, a clear register signal is illustrated for each port at 520.

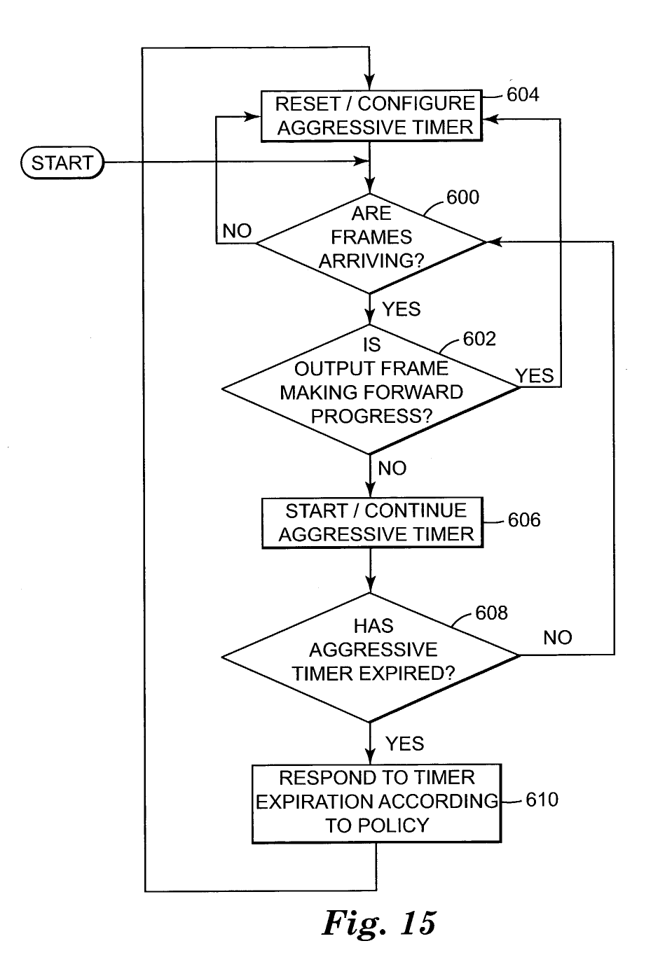

FIG. 15 illustrates an example operation of the aggressive timer 512 of one port 502 of routing element 500. As indicated at 600, aggressive timer 512 monitors transmission demand 515 of transmit queue 506. As indicated at 602, aggressive timer 512 monitors transmission status 514. Under non-congested, or unexceptional operating conditions, frames are either making forward progress or not arriving into transmit queue 506. Therefore, under unexceptional circumstances, aggressive timer 512 remains in a reset state or is in a state receptive to configuration signal 522, as indicated at 604.

If an exception occurs at a time when frames are arriving and when the output frame in transmit register 508 does not make forward progress, then aggressive timer 512 starts counting at 606. At 608, an inquiry and decision is made as to whether aggressive timer 512 has expired. If aggressive timer 512 has not expired and the exceptional conditions remain, then aggressive timer 512 continues applying the configured variable timing threshold, as indicated at 606. If the aggressive timer 512 has not expired but the exceptional circumstances no longer exist, then aggressive timer 512 is rest at 604 and the normal non-exceptional operating mode described above resumes. If, however, aggressive timer 512 expires, then traffic congestion manager 516 takes an appropriate action and response to the aggressive timer 512′ expiration, such as dropping one or more frames from transmit queue 506 and/or receive register 504. Aggressive timer 512 is then reset and/or reconfigured, as indicated at 604.

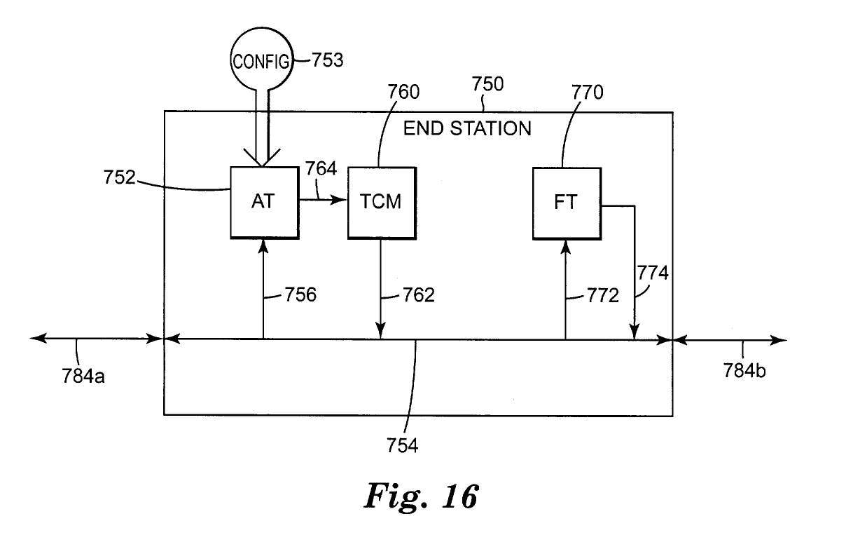

FIG. 16 illustrates an exemplary embodiment of an end station 750 having an aggressive timer 752 and a forward progress timer 770. End station 750 transmits or receives network traffic 754 via links 784a and 784b.

Aggressive timer 752 provides timewise monitoring of network traffic 754 via a monitoring mechanism 756, and according to aggressive timer configuration 753. Upon expiration, aggressive timer 752 provides a timer expiration indication 764. Traffic congestion manager 760 receives expiration indication 764, and provides a selected response 762 according to network traffic management policy for aggressively-timed network traffic. Forward progress timer 770 monitors network traffic 754 for an occurrence of a severe congestion indication 772, and according to preselected timing criteria. Forward progress timer 770 provides a response action 774 according to network traffic management policy for forward progress-timed network traffic.

Forward progress timer 770 is generally employed to facilitate a solution for severe, abnormal congestion. Forward progress timer 770 receives severe congestion indication 772 when end station 750 cannot send a frame after a long time, such as for tens or hundreds of milliseconds. In response, forward progress timer 770 takes one or more actions 774 for relieving the congestion.

Conversely, aggressive timer 752 is generally employed to facilitate implementation of a congestion management policy by recognizing and responding to early indications of congestion or bandwidth underutilization. Thus, exemplary aggressive timer 752 is implemented with finer granularity than the forward progress timer 770. In one embodiment, the aggressive timer 752 has a counting rate that is a multiple of forward progress timer 770's counting rate. In one embodiment, aggressive timer 752 has microsecond resolution.

The following Pseudo-Code I demonstrates the timing and congestion management functionality of an exemplary end station having a forward progress timer (FT) and an aggressive timer (AT).

PSEUDO-CODE I

while (frames are arriving to buffer) {

if (output port frame cannot make forward progress) {

start AT on output port
start FT on output port

} else

reset AT and FT

}
Exception Processing:

if (AT expires and FT has not) {

reset AT
respond according to congestion management policy

} else if (FT expires) {

reset AT and FT
discard frames for a period of time defined by architecture

}
Update link-level flow control as required

Although specific embodiments have been illustrated and described herein for purposes of description of the preferred embodiment, it will be appreciated by those of ordinary skill in the art that a wide variety of alternate and/or equivalent implementations calculated to achieve the same purposes may be substituted for the specific embodiments shown and described without departing from the scope of the present invention. Those with skill in the chemical, mechanical, electro-mechanical, electrical, and computer arts will readily appreciate that the present invention may be implemented in a very wide variety of embodiments. This application is intended to cover any combinations, adaptations or variations of the preferred embodiments discussed herein. Unless otherwise described, no single embodiment is exclusive of any other described embodiment. Therefore, it is manifestly intended that this invention be limited only by the claims and the equivalents thereof.

What is claimed is:

1. A network system comprising:
links;
end stations coupled between the links, wherein types of end stations include endnodes which originate or consume frames and routing devices which route frames between the links, wherein at least one end station includes:
an aggressive timer adapted to respond to an occurrence of at least one condition of delayed frame transmission progress to provide a first frame delay indication when the at least one condition exists for a duration that exceeds a variable timing threshold, wherein the variable timing threshold is configurable based on at least one network system attribute.

2. The network system of claim 1, wherein the variable timing threshold is configurable by adjusting a timing rate of the aggressive timer.

3. The network system of claim 1, wherein the variable timing threshold is configurable by adjusting a timing interval that includes a configurable ending time relative to a starting time.

4. The network system of claim 1, wherein the aggressive timer is configurable to be disabled.

5. The network system of claim 1, wherein the at least one network system attribute includes a traffic congestion management policy.

6. The network system of claim 1, wherein the at least one network system attribute includes an end station's at least one attribute.

7. The network system of claim 1, wherein the at least one network system attribute includes at least one attribute of the network system's architecture.

8. The network system of claim 1, wherein the at least one network system attribute includes at least one frame attribute.

9. The network system of claim 8 wherein the at least one frame attribute includes the frame size.

10. The network system of claim 8 wherein the frame attribute includes the type of information carried by the frame.

11. The network system of claim 8 wherein the at least one frame attribute includes a frame header attribute.

12. The network system of claim 8 wherein the at least one frame attribute includes an assigned service level of frame transmission.

13. The network system of claim 1 wherein the at least one network system attribute includes at least one intended destination end station for the frame.

14. The network system of claim 1 wherein the at least one network system attribute includes a type of transport service used for frame transmission.

15. The network system of claim 1 wherein the at least one network system attribute includes at least one predetermined network system attribute.

16. The network system of claim 1 wherein the at least one network system attribute includes a measured network system status.

17. The network system of claim 1 wherein the at least one network system attribute includes at least one frame transmission path's bandwidth attributes.

18. The network system of claim 17 wherein the bandwidth attributes include a frame's next link hop.

19. The network system of claim 1 wherein the at least one end station includes a port, and wherein the at least one network system attribute includes at least one attribute of the port.

20. The network system of claim 19 wherein the at least one port attribute includes back pressure from the port.

21. The network system of claim 19 wherein the at least one port attribute includes a congestion status history of the port.

22. The network system of claim 19 wherein the at least one port attribute includes transmission demands of the port.

23. The network system of claim 1 wherein the at least one network system attribute includes a type of workload of at least one application running on at least one end station.

24. The network system of claim 1, wherein the variable timing threshold is configurable based on at least one previous frame delay indication.

25. The network system of claim 1, wherein the at least one end station further comprises:
a forward progress timer adapted to provide a second frame delay indication when at least one delay in frame transmission exceeds a preset timing threshold that is greater than the variable timing threshold.

26. The network system of claim 1 wherein the aggressive timer is configured to count at a microsecond granularity.

27. The network system of claim 1, further comprising at least one traffic congestion manager adapted to respond to the first frame delay indication.

28. The network system of claim 27 wherein the at least one traffic congestion manager's response includes dropping at least one frame.

29. The network system of claim 28 wherein the frame dropping is based on at least one type of randomizing means for selecting frames to be dropped.

30. The network system of claim 28 wherein the frame dropping is based on applying at least one criterion for discriminating among frames based on frame attributes.

31. The network system of claim 28 wherein the at least one traffic congestion manager's response includes dropping a set of frames, all of which have at least one common attribute.

32. The network system of claim 27 wherein the at least one traffic congestion manager's response includes truncating at least one frame.

33. The network system of claim 27 wherein the at least one traffic congestion manager's response includes communicating traffic congestion information to at least one other end station.

34. The network system of claim 33 wherein the at least one traffic congestion manager's response includes generating at least one congestion reporting frame.

35. The network system of claim 33 wherein the at least one traffic congestion manager's response includes tagging at least one frame with information relating to congestion status of the at least one frame's routing path.

36. The network system of claim 27 wherein the at least one traffic congestion manager's response includes storing a record that is representative of the first frame delay indication.

37. The network system of claim 27 wherein the at least one traffic congestion manager is dynamically configurable based on at least one network system attribute.

38. The network system of claim 37 wherein the at least one traffic congestion manager is dynamically configurable based on the first frame delay indication.

39. The network system of claim 27 wherein the at least one traffic congestion manager is included in the at least one end station.

40. A network system comprising:
links;
end stations coupled between the links, wherein types of end stations include endnodes which originate or consume frames and routing devices which route frames between the links, wherein at least one end station includes:
a forward progress timer adapted to provide a first frame delay indication when at least one delay in frame transmission exceeds a first timing threshold; and
an aggressive timer adapted to respond to an occurrence of at least one condition of delayed frame transmission progress, to provide a second frame delay indication when the at least one condition exists for a duration that exceeds a second timing threshold, wherein the second timing threshold is configurable based on at least one network system attribute.

41. The network system of claim 40 wherein the first timing threshold is greater than the variable timing threshold.

42. The network system of claim 40 wherein the configurable second timing threshold is variable in duration.

43. The network system of claim 40 wherein the forward progress timer is configured to count at a first counting rate, and the aggressive timer is configured to count at a second counting rate that is a multiple of the first counting rate.

44. The network system of claim 40 wherein the aggressive timer is configured to count at a microsecond granularity.

45. The network system of claim 40, wherein the at least one network system attribute includes at least one frame attribute.

46. The network system of claim 40, wherein the at least one end station includes a port, and wherein the at least one network system attribute includes at least one attribute of the port.

47. The network system of claim 40 wherein the at least one network system attribute includes a traffic congestion management policy.

48. The network system of claim 40 wherein at least one end station is configured to respond to at least one of the first and second frame delay indications.

49. The network system of claim 48 wherein the at least one end station comprises:
a traffic congestion manager configured to respond to the second frame delay indication.

50. The network system of claim 49 wherein the traffic congestion manager is configurable based on at least one network system attribute.

51. An end station comprising:
an aggressive timer adapted to monitor network traffic, and respond to an occurrence of at least one condition of delayed frame transmission progress to provide a first frame delay indication when the at least one condition exists for a duration that exceeds a variable timing threshold, wherein the variable timing threshold is configurable based on at least one network system attribute.

52. The end station of claim 51, further comprising at least one routing device.

53. The end station of claim 52 wherein the at least one routing device includes at least one switch.

54. The end station of claim 52 wherein the at least routing device includes at least one router.

55. The end station of claim 51, further comprising at least one processor endnode.

56. The end station of claim 51, wherein the monitored network traffic is monitored within the end station.

57. The end station of claim 51, wherein the at least one network system attribute includes at least one frame attribute.

58. The end station of claim 51, further comprising a port, wherein the at least one network system attribute includes at least one attribute of the port.

59. The end station of claim 51, wherein the at least one network system attribute includes a traffic congestion management policy.

60. The end station of claim 51, wherein the end station is configured to generate an indication upon the aggressive timer's recognition of the potential condition of network bandwidth underutilization.

61. The end station of claim 51, wherein the end station is configured to respond to the aggressive timer's recognition of the potential condition of network bandwidth underutilization.

62. The end station of claim 61 further comprising:
a traffic congestion manager, wherein the traffic congestion manager is configured to render the response.

63. The end station of claim 62 wherein the traffic congestion manager is configurable based on at least one network system attribute.

64. A method of detecting potential network system bandwidth underutilization, the method comprising:
configuring a timing threshold that defines when a continuous existence of at least one condition of delayed frame transmission progress constitutes an underutilization of network system bandwidth, wherein the configuring is based on at least one network system attribute; and
monitoring transmission progress of a frame, wherein the monitoring includes:
responding to any indicated existence of the at least one condition of delayed frame transmission progress;
timing the duration of the existence of the at least one condition; and
comparing the measured duration against the configured timing threshold.

65. The method of claim 64, wherein the responding to any indicated existence of the at least one condition of delayed frame transmission progress, includes initiating the timing.

66. The method of claim 64, further comprising:
providing a frame delay indication when the measured duration exceeds the timing threshold.

67. The method of claim 64, further comprising:
managing network traffic congestion when the measured duration exceeds the timing threshold.

68. The method of claim 67 wherein the managing is based on a network traffic congestion management policy.

69. The method of claim 64 wherein the at least one network system attribute includes a traffic congestion management policy.

70. The method of claim 64 wherein the at least one network system attribute includes an end station's at least one attribute.

71. The method of claim 70 wherein the at end station's least one attribute includes at least one port attribute.

72. The method of claim 64 wherein the at least one network system attribute includes at least one frame attribute.
